(19) United States
(12) Patent Application Publication
(10) Pub. No.: US 2026/0169823 A1
(43) Pub. Date: Jun. 18, 2026

(54) SYSTEM, METHODS, AND MEDIA FOR DECENTRALIZED INFRASTRUCTURE FOR COORDINATED PROVISIONING AND EXECUTION OF WORKLOADS

(71) Applicant: Sai Yammada, Suwanee, GA (US)

(72) Inventor: Sai Yammada, Suwanee, GA (US)

(21) Appl. No.: 19/425,353

(22) Filed: Dec. 18, 2025

Related U.S. Application Data
(60) Provisional application No. 63/735,552, filed on Dec. 18, 2024.

(51) Int. Cl. G06F 9/50

(52) U.S. Cl. CPC G06F 9/5077

(57) ABSTRACT

A decentralized infrastructure enables devices to contribute compute, storage, and networking resources to a shared distributed environment. A registering device provides a registration request to one or more control devices, which determine the device's resource capabilities and direct creation of resource modules that expose those capabilities for use within the infrastructure. The control devices register the device in a pool of resource devices and receive service requests from other devices. A selected device is chosen based on current resource availability, provisioned with workloads, and instructed to execute those workloads and generate results, which are communicated back to the requesting device.

### BENEFIT CLAIMS; RELATED APPLICATIONS; INCORPORATION BY REFERENCE

This application claims the benefit of U.S. Provisional Patent Application No. 63/735,552, filed Dec. 18, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to distributed computing systems. In particular, the present disclosure relates to decentralized infrastructure architectures that coordinate heterogeneous computing, storage, and networking resources contributed by multiple independent devices to provide scalable, policy-aware execution of workloads across regions and jurisdictions.

### BACKGROUND

Existing distributed computing environments commonly rely on centralized data centers or tightly controlled clusters of servers to execute applications, store data, and provide networked services. These systems typically assume that participating hardware is homogeneous, centrally administered, and continuously available. As a result, conventional architectures may underutilize the substantial amount of compute, storage, and network capacity present on personal computers, mobile devices, edge systems, and other heterogeneous hardware distributed across the Internet. At the same time, increasing demand for low-latency processing, regional data handling, and flexible workload placement has highlighted limitations in traditional centralized approaches. Techniques for securely coordinating diverse devices, managing varying resource capabilities, and enforcing region-specific or policy-based constraints across large, decentralized environments continue to evolve, and improvements in these areas may enhance scalability, reliability, and efficiency in distributed computing systems.

### SUMMARY

The systems and methods described herein provide a decentralized infrastructure that enables heterogeneous devices—such as personal computers, mobile devices, servers, and IoT systems—to contribute compute, storage, and networking resources into a unified, policy-aware resource pool. A control plane associated with one or more regions manages onboarding of new devices, determines their available capabilities, provisions standardized resource modules on those devices, and registers them as worker nodes capable of servicing requests. Service requests received from user or application devices may then be matched to suitable worker nodes based on factors such as resource availability, performance metrics, geographic location, or administrative policies. Selected worker nodes may be provisioned with one or more workloads, execute those workloads, generate results, and return the results to the requesting device through secure communication paths. In various embodiments, the decentralized infrastructure may span multiple regions, support region-specific or jurisdiction-specific policies, utilize secure overlay networks for intra- and inter-region communication, and operate using a wide variety of underlying device types. The techniques described herein enable scalable, resilient, and policy-compliant execution of distributed workloads across a global population of contributed devices.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates an example decentralized infrastructure architecture including a regional control plane, worker nodes, and external interfaces.

FIG. 2 illustrates an example multi-region architecture showing secure inter-region communication links and regional selection.

FIG. 3 illustrates an example intra-regional communication architecture including admin nodes, control nodes, worker nodes, and domain name server (“DNS”) components.

FIG. 4 illustrates an example sequence of operations for authenticating a user and routing a service request to a worker node.

FIG. 5 illustrates example device-level networking illustrating how personal, mobile, and IoT devices may join the decentralized infrastructure.

FIG. 6 illustrates an example method for registering a new device as a worker node.

FIG. 7 illustrates an example method for servicing a request using registered worker nodes.

FIG. 8 illustrates an example computing system suitable for implementing control devices, admin nodes, worker nodes, or user devices.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The systems and methods described herein address a fundamental limitation in existing cloud and distributed-computing models: modern computational demand is increasingly global, latency-sensitive, regulatorily constrained, and economically inefficient to satisfy using centralized data centers alone. At the same time, billions of personal computers, mobile devices, and internet-of-things (“IoT”) systems across the world possess substantial unused compute, storage, and networking capacity that remains inaccessible to traditional cloud architectures. The invention provides a technical framework that securely aggregates these heterogeneous, intermittently connected devices into a unified decentralized infrastructure, enabling them to operate as a coordinated global fabric capable of running distributed applications, hosting storage, and satisfying service requests under strict policy, security, and jurisdictional constraints.

To accomplish this, the invention introduces a layered architecture that turns arbitrary participant devices into standardized resource-providing worker nodes. The control planes of regional clusters manage these devices, maintain capability and policy information, and orchestrate workloads. Each device that seeks to participate undergoes a structured onboarding process: it sends a registration request, reports its available capabilities, receives a resource module that virtualizes its contributed compute/storage/network resources, and becomes part of a managed resource pool. This converts otherwise idle capacity into safely isolated, policy-governed execution environments without compromising the device owner's primary use of the hardware.

Once devices are registered, service requests originating from users or applications can be dispatched to suitable worker nodes. The invention provides mechanisms for selecting nodes based on resource availability, geographic and legal constraints, performance characteristics, and administrative policies. The system provisions workloads onto selected nodes using standardized resource modules and executes those workloads while maintaining secure communication channels, telemetry, and fault-tolerant monitoring. Results generated at worker nodes are then securely communicated back to the requesting device. This allows the system to behave as a global, policy-aware distributed cloud built from consumer and edge devices rather than relying solely on centralized servers.

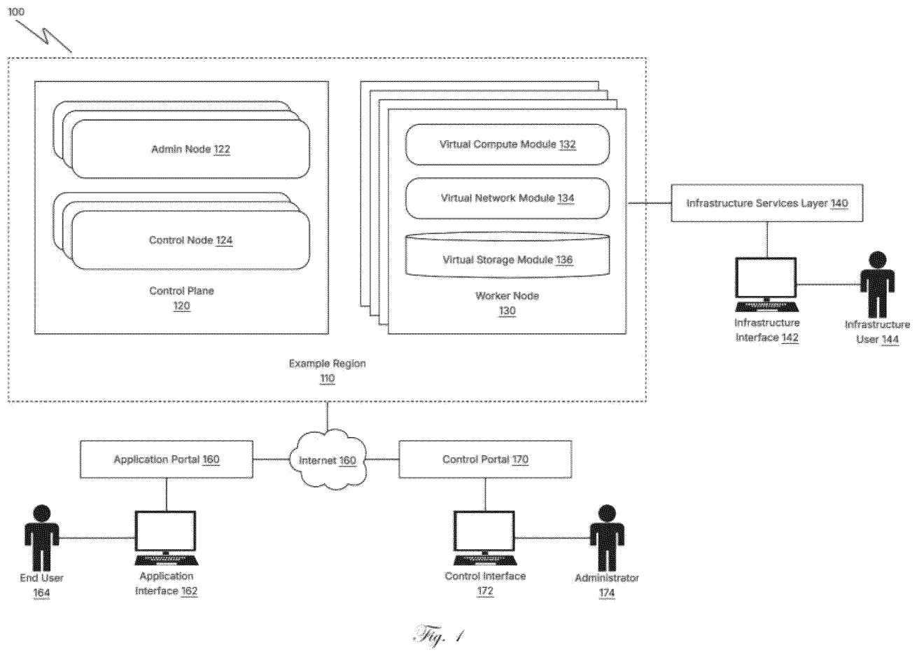

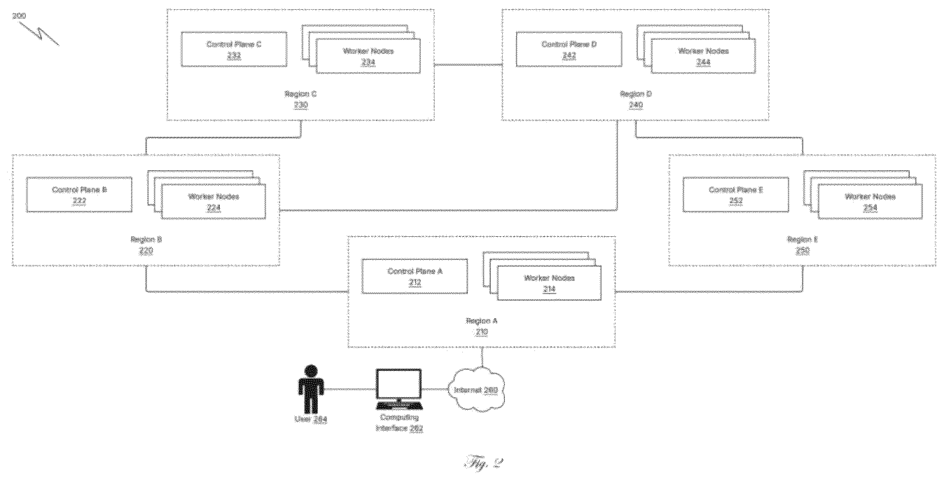

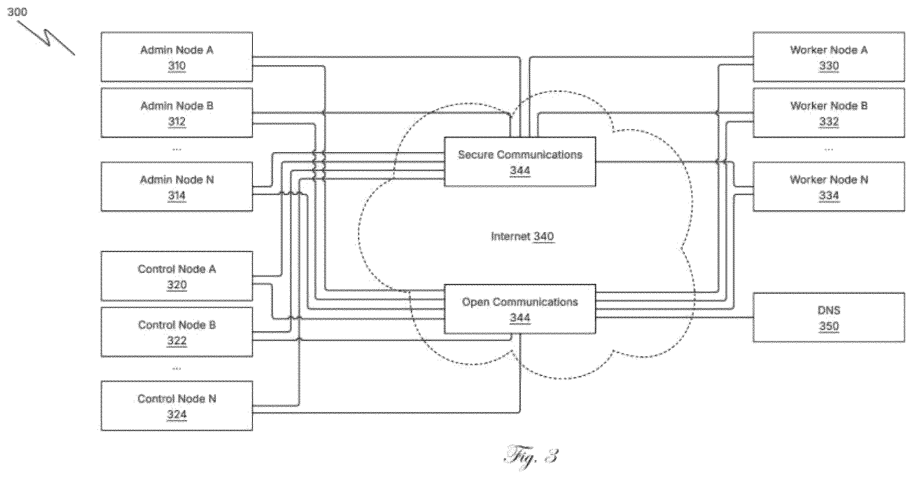

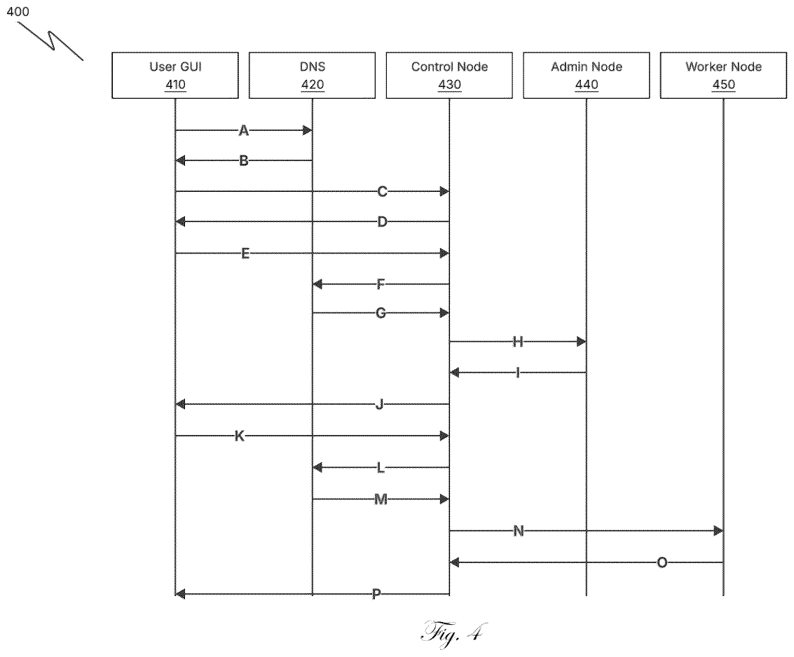

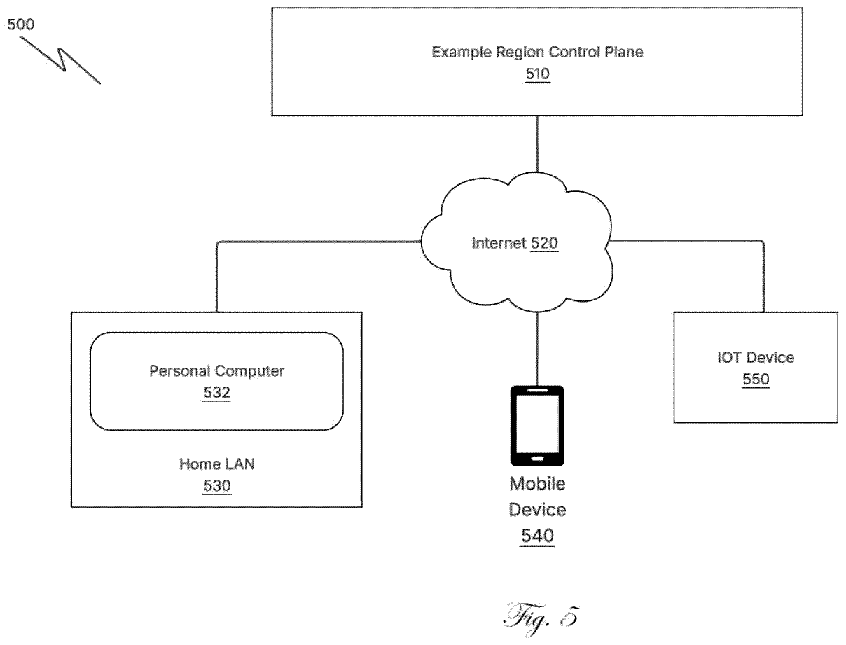

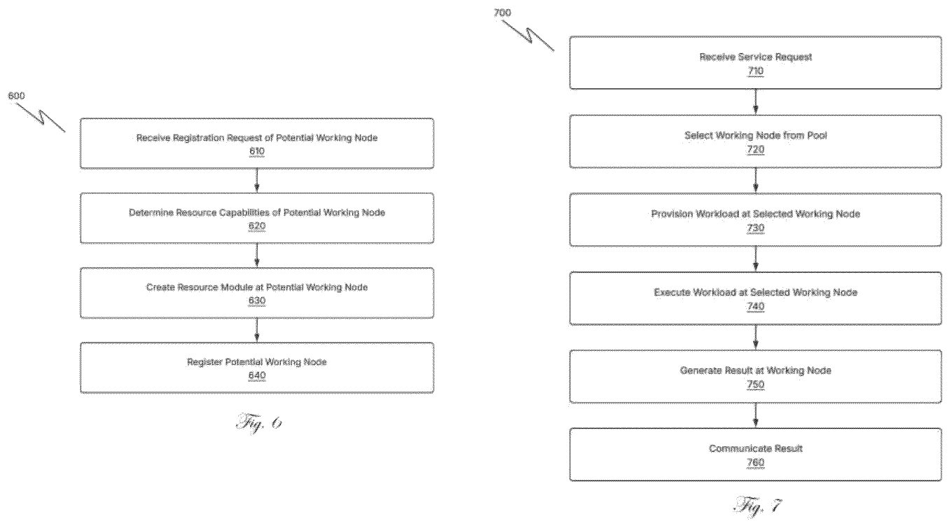

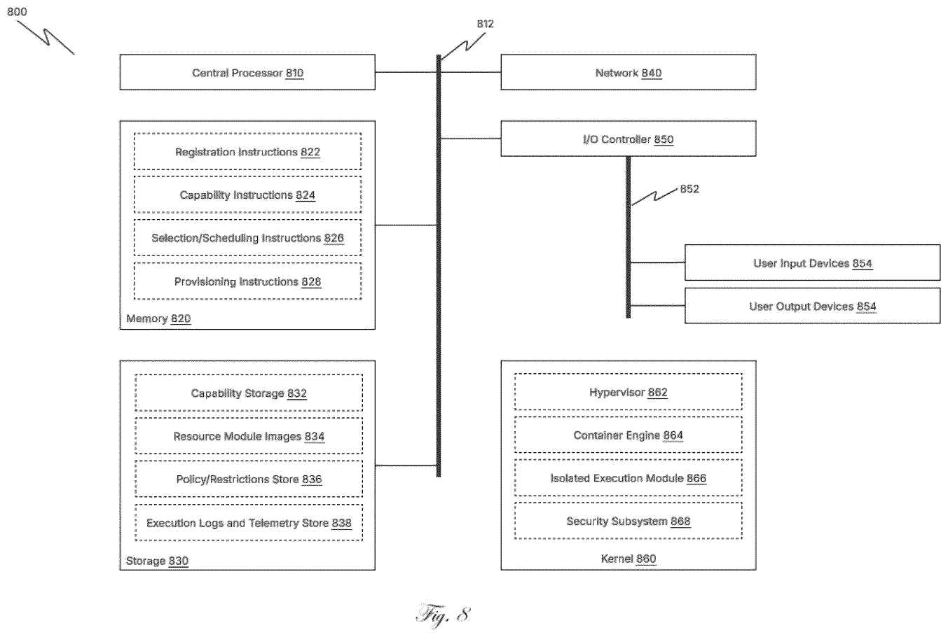

The architectural components described in the figures illustrate progressively narrower views of the system. FIG. 1 introduces the conceptual regional layout of control planes, worker nodes, and user access points. FIG. 2 expands this view to show how regions interconnect through secure overlay links to form a geographically distributed global mesh. FIG. 3 focuses on intra-regional communication paths, demonstrating how administrative and control nodes coordinate worker nodes using secure overlay channels and resilient failover mechanisms. FIG. 4 provides an interaction-level sequence that follows a user request through DNS resolution, authentication, node selection, workload execution, and response delivery. FIG. 5 zooms in further to demonstrate how personal devices, mobile hardware, and IoT systems attach to the infrastructure and become worker nodes through secure tunnels and resource virtualization. FIG. 6 and FIG. 7 then set out the two core operational methods: registering a device into the network and servicing a user's request using registered nodes. Finally, FIG. 8 provides a generalized computing-system architecture that can implement any of the nodes—control nodes, admin nodes, worker nodes, or user devices—by incorporating processors, memory, storage, virtualization layers, security modules, and network interfaces specifically arranged to carry out the operations of the invention.

Together, the disclosed examples illustrate a coherent system for transforming globally distributed, heterogeneous, ephemeral, and user-controlled devices into a managed, policy-compliant, secure, and resilient compute fabric. The invention solves problems of resource fragmentation, centralized-infrastructure latency, cross-border data control, and underutilization of edge compute capacity by introducing a unifying orchestration framework capable of allocating, securing, and supervising workloads running on a worldwide population of contributed devices.

FIG. 1 illustrates an example embodiment of a decentralized infrastructure architecture 100 that may be used to provide distributed compute, storage, and networking capabilities. Architecture 100 may include a plurality of components arranged within a representative geographic region identified as example region 110, although the arrangement shown is only one possible configuration. Additional or alternative regions, nodes, network paths, and service components may be used in other embodiments.

Example region 110 may include a control plane 120, which may coordinate operation of devices participating in the region. The control plane 120 may include one or more admin nodes 122 and one or more control nodes 124, each of which may be hosted on any suitable device capable of participating in the decentralized infrastructure. Admin nodes 122 may provide administrative, monitoring, logging, configuration, auditing, or policy-management functions for the region. Control nodes 124 may maintain information about worker nodes 130 in the region, manage node membership, distribute workloads, maintain routing or overlay connectivity information, authenticate user requests, and perform orchestration activities. The admin nodes 122 and control nodes 124 may communicate with one another over secure channels, which may be implemented using mutual transport layer security (“MTLS”) sessions, encrypted tunnels, or other protected communication mechanisms.

In some embodiments, the admin nodes 122 and control nodes 124 may perform different but complementary functions within the control plane 120. Admin nodes 122 may operate primarily as supervisory or management-oriented systems that may maintain configuration data, regional policy definitions, security credentials, logging services, audit trails, or administrative user interfaces. These nodes may provide higher-level governance or oversight for the region and may be responsible for distributing settings, accepting administrator modifications, or enforcing compliance with regional or global operating requirements. Control nodes 124, by contrast, may operate as real-time orchestration components that may maintain active knowledge of worker node availability, resource capacity, and network topology. A control node 124 may assign workloads, initiate resource allocation, maintain membership lists, and direct communication flows between worker nodes 130 or toward external portals. While admin nodes 122 may maintain long-term configuration state, the control nodes 124 may react dynamically to current operating conditions. Admin nodes and control nodes may communicate frequently, but each may be optimized for a distinct subset of regional responsibilities. In an embodiment, the admin nodes 122 and control nodes 124 are integrated into a single node or cluster of nodes. In an embodiment, all control nodes 124 are integrated into a single control node. In an embodiment, all admin nodes 122 are integrated into a single admin node.

Example Region 110 may further include on or more worker nodes 130, each of which may be contributed by a participant device such as a personal computer, mobile device, IoT device, server, virtual machine, or other computing system. Each worker node 130 may execute node software that enables the node to contribute compute, storage, and networking capacity to the region. Worker nodes may appear in FIG. 1 as a stack to indicate that multiple such nodes may exist within a region, although any number of worker nodes may be present in a given implementation. In practice, the control plane 120 and the worker nodes 130 may be physically distributed throughout Example Region 110 and interconnected via the Internet 150 or other underlying public or private networks, even though they are depicted within a single conceptual boundary for clarity.

A worker node 130 may instantiate various virtualized resource modules, which may collectively provide standardized compute, storage, and network abstractions for use by applications or services. As shown, a worker node 130 may include a virtual compute module 132, a virtual network module 134, and a virtual storage module 136. The virtual compute module 132 may supply isolated execution environments such as containers or virtual machines. The virtual network module 134 may establish encrypted overlay paths, virtual interfaces, or routing rules enabling the node to communicate with the control plane or other nodes. The virtual storage module 136 may expose object storage, block storage, volume services, or other forms of persistent or semi-persistent data storage. Each of these modules may be created, modified, or deallocated under the direction of control nodes 124 in response to service requests or changes in regional capacity.

In some embodiments, the virtual compute module 132 of a worker node 130 may support containerized execution environments. For example, the node software may instantiate one or more containers that may isolate workloads from one another and provide standardized execution interfaces regardless of the underlying device type. Containerization may allow each worker node to execute microservices, application fragments, or other computational tasks in a lightweight and portable manner. Containers may be deployed, updated, suspended, or terminated based on instructions received from the control nodes 124, and may also interact with the virtual storage module 136 or virtual network module 134 as needed. Other execution environments may also be used, including virtual machines, interpreted environments, sandboxed processes, or hardware-accelerated runtimes, and a given worker node may support any combination of such environments depending on available resources.

Worker nodes 130 may periodically provide heartbeat signals, status reports, resource availability information, or performance metrics to the control plane 120. Based on this information, control nodes 124 may assign workloads to specific worker nodes, redirect service traffic, initiate replication or migration of data, or adjust resource allocations. In some examples, the control nodes may also receive summarized state information from control planes in other regions, allowing global load-balancing or inter-regional routing optimizations to occur.

Example Region 110 may interact with external users and systems through several interfaces. An infrastructure services layer 140 may provide an infrastructure user 144, operating through an infrastructure interface 142, with access to infrastructure-level capabilities such as compute, storage, networking, or resource-sharing functions. The infrastructure services layer 140 may communicate with the control plane 120 to provision virtual modules on worker nodes, establish connectivity rules, or allocate resource quantities requested by the infrastructure user 144. In FIG. 1, the infrastructure services layer 140 is depicted as being directly connected to a worker node 130 to illustrate that, in some deployments, an infrastructure user 144 may operate a local terminal that is itself a worker node or is directly attached to a worker node within example region 110. In other embodiments, the infrastructure services layer 140 may be hosted remotely and may be accessed via the Internet 150 or other networks, and need not reside on or adjacent to a particular worker node.

An application portal 160 may allow an end user 164, using an application interface 162, to access one or more applications deployed within example region 110 or elsewhere in the decentralized system. The application portal may perform authentication, generate session information, route user requests to the nearest available region, or return results generated by worker nodes 130. The application portal 160 may communicate with the region through the Internet 150, which may encompass any combination of public networks, private networks, wireless networks, satellite links, or other communication media. Although FIG. 1 depicts the application portal 160 communicating with the computing interface 162 through the Internet 150, in some implementations the application portal 160 may reside on the same local network, or even on the same physical terminal, as the end user 164, thereby allowing direct connectivity that does not traverse public networks.

A control portal 170 may allow an administrator 174, operating a control interface 172, to inspect or modify configuration settings for example region 110. The control portal 170 may retrieve state information from the control plane 120, initiate changes to policy definitions, authorize or revoke node participation, or examine system behaviors such as performance metrics, audit logs, or access events. The control portal 170 may communicate securely with admin nodes 122 or control nodes 124, although other communication paths may also be used. Similar to the application portal 160, the control portal 170 may in some embodiments be deployed on a terminal or local network directly accessible to the administrator 174, without requiring traversal of the public Internet 150.

In operation, a service request originating from the application portal 160 may be directed to a control node 124, which may select one or more worker nodes 130 that satisfy the resource requirements of the requested service. For instance, the control node may allocate compute capacity on a virtual compute module 132, assign associated virtual networking attributes through a virtual network module 134, and create or attach storage resources through a virtual storage module 136. The selected worker node 130 may then execute the requested service and return results to the end user 164 through the application interface 162. Similar interactions may occur in response to infrastructure requests arriving through the infrastructure services layer 140, where an infrastructure user 144 may request creation of resource pools, deployment of microservices, setup of private virtual networks, or other infrastructure operations.

Admin nodes 122 and control nodes 124 may also interact with one another to maintain region stability. For example, if a worker node becomes unreachable, the control nodes may update membership information and reassign workloads to other available worker nodes. If a new device attempts to join example region 110, the control plane 120 may authenticate the device, create necessary overlay connections through the device's virtual network module 134, and incorporate the device's compute, storage, or network capacity into the resource pool available for allocation.

Although FIG. 1 focuses on a single region for clarity, multiple such regions may exist in the system, and each may include a control plane, worker nodes, external interfaces, and associated user access pathways. Regions may exchange summarized state information or routing metadata, allowing the system to form a global decentralized infrastructure that may scale across numerous distinct geographic or logical boundaries.

As shown in FIG. 2, a user 264 may interact with the decentralized infrastructure through a computing interface 262 connected to the internet 260. Computing interface 262 may correspond to the application interface 162, infrastructure interface 142, or control interface 172 of FIG. 1 and may be used by an end user, an infrastructure user, or an administrator, respectively. Depending on the particular role, the computing interface 162 may communicate with an application portal, a control portal, or an infrastructure services layer as described with respect to FIG. 1. For example, an end user may access an application portal to consume deployed applications, an infrastructure user may access an infrastructure services layer to provision virtualized infrastructure, and an administrator may access a control portal to configure or monitor regional behavior. Regardless of role, initial network communication from computing interface 262 may reach the decentralized system through public or private network paths collectively represented by Internet 260.

In operation, when a request is initiated from computing interface 262, a global routing or region-selection process may determine an appropriate region to handle the request based on one or more criteria. Although not separately illustrated in FIG. 2, this process may be implemented using DNS records, anycast addressing, geolocation logic, or other routing mechanisms that direct the request toward a selected one of the regions 210-250. In some embodiments, the region-selection process may attempt to route the request to the geographically closest region to reduce network latency and improve user experience. In other embodiments, region selection may consider measured or estimated latency, available capacity, historical reliability, cost, or policy constraints, and may dynamically select a region that best satisfies a combination of these metrics.

FIG. 2 further illustrates that not every region in architecture 200 is directly connected to every other region. Instead of a full mesh, selected pairs of regions may be joined by secure inter-region links that form a partial mesh or multi-hop topology. For instance, Region A 210 may be directly connected to Region B 220 and Region E 250, while Region C 230 and Region D 240 may be connected through intermediary regions. Thus, a control plane in one region may reach another region either through a direct link or by forwarding messages through one or more intermediate control planes. This arrangement allows the decentralized infrastructure to scale to many regions without requiring an impractically large number of direct connections.

Inter-region links between regions 210-250 may be implemented as encrypted overlay channels established between control planes. For example, control plane A 212 may maintain one or more MTLS sessions, virtual private network (“VPN”) tunnels, or other secure overlay connections with control plane B 222 and control plane E 252. Similarly, control planes C 232 and D 242 may maintain secure overlay connections with neighboring control planes as shown. These encrypted links may carry heartbeat messages, summarized resource availability data, routing tables, policy updates, and other metadata necessary for global coordination. In some embodiments, the overlay connections may operate at Layer 3 using user datagram protocol (“UDP”) or transmission control protocol (“TCP”) transport and may encapsulate higher-level protocols used by the control planes.

The use of multiple regions connected by secure inter-region links may provide several technical advantages. Because each region 210-250 maintains its own local control plane and worker nodes, services deployed in one region may continue to operate even if another region becomes partially or completely unavailable. Thus, a failure affecting Region B 220, for example, may not directly impact the ability of Region A 210, Region C 230, Region D 240, or Region E 250 to continue serving requests. In addition, by directing users to a region geographically or topologically close to them, the system may reduce round-trip latency, increase throughput, and improve responsiveness. Workloads may be shifted among regions in response to demand, allowing the system to perform cross-region load balancing and to avoid overloading any particular region.

The regional organization depicted in FIG. 2 may also support legal, regulatory, or contractual requirements related to data sovereignty and privacy. For example, Region B 220 may correspond to a geographic area governed by a first data protection regime, while Region C 230 may correspond to another jurisdiction governed by a second regime. Policies enforced by the respective control planes 222 and 232 may restrict certain categories of data from leaving the region or may require that specific workloads be executed only on worker nodes within the originating region. When the region-selection process receives a request associated with data subject to such constraints, it may select a region whose policies and geographic location satisfy the applicable requirements and may avoid routing the request to regions whose laws or policies would not permit processing that data.

In some embodiments, inter-region links may enforce or respect these legal constraints by propagating only anonymized, aggregated, or metadata-level information between regions. For example, control planes 212, 222, 232, 242, and 252 may exchange capacity summaries, health status, or routing hints without transmitting underlying user data or application payloads. Where cross-region data movement is permitted, the inter-region overlay may apply additional encryption, access control, or logging rules. Thus, the multi-region architecture may allow the decentralized system to present a logically unified infrastructure while preserving per-region control over data residency, retention, and access policies.

The partially connected topology of FIG. 2 may also enable incremental deployment and organic growth of the decentralized infrastructure. New regions may be added over time by establishing secure overlay links with one or more existing regions rather than connecting directly to every region already in operation. Likewise, a region may be temporarily isolated from certain other regions if network conditions, policy changes, or administrative decisions warrant such isolation, while still maintaining connectivity through permitted intermediary regions. The arrangement of regions, control planes, worker nodes, and inter-region links shown in FIG. 2 therefore represents only one example of how a global decentralized compute, storage, and networking system may be constructed, and other topologies may be used without departing from the underlying concepts of regional autonomy, secure coordination, and policy-aware routing.

In some embodiments, the decentralized infrastructure may be organized so that each country or other geographic or legal jurisdiction includes one or more regions that are treated as a logical cluster for that jurisdiction. For example, a jurisdiction may include a single region comprising multiple control planes and worker nodes, or may include several regions distributed across different metropolitan areas that nonetheless share a common policy set and may freely exchange tasks and information with one another. Within such a jurisdictional cluster, control planes may route service requests, replicate data, and rebalance workloads among local regions with relatively few restrictions, thereby improving latency, resilience, and resource utilization for users in that country or area. At the same time, communications between regions belonging to different jurisdictions may be subject to additional technical and policy constraints defined by one or more administrators. For instance, cross-border traffic may be limited to anonymized metadata, aggregated metrics, or encrypted payloads meeting certain compliance requirements, while specific categories of data—such as personally identifiable information or regulated health or financial records—may be tagged and constrained to remain within the originating jurisdictional cluster. Administrators may define rules that govern when a region in one jurisdiction can request resources from a region in another jurisdiction, which control planes are permitted to participate in cross-border failover, what encryption or logging requirements apply, and under what conditions data or workloads may be replicated outside a given geographic or legal boundary.

FIG. 3 illustrates an example intra-regional communication architecture 300 that may be used within a single region to interconnect administrative components, control components, worker nodes, and name-resolution services. Although FIG. 3 depicts a particular arrangement of nodes and communication paths, other arrangements, quantities of nodes, or network topologies may be used in other embodiments. The nodes illustrated in FIG. 3 may correspond to physical devices, virtual machines, containers, or logical services executing on participant hardware distributed throughout the region.

A plurality of admin nodes may be present, including Admin Node A 310, Admin Node B 312, and Admin Node N 314, where “N” represents any number of additional admin nodes that may be added to increase resiliency or capacity. Admin nodes 310-314 may provide configuration management, logging, auditing, metrics aggregation, credential storage, regional policy enforcement, and administrative user interfaces. In an embodiment, the admin nodes may operate in a highly available or fault-tolerant arrangement in which two or more admin nodes maintain synchronized state. For example, admin nodes may replicate configuration values, policy definitions, and administrative metadata using consensus protocols such as Raft, Paxos, Viewstamped Replication, or other distributed-agreement mechanisms. If one admin node becomes unreachable, another admin node may seamlessly continue providing administrative services without requiring manual intervention. In some embodiments, a quorum-based model may be used to ensure that only one admin node assumes the authoritative role at a time, while the remaining admin nodes serve as hot standbys.

A plurality of control nodes may also be present, such as Control Node A 320, Control Node B 322, and Control Node N 324. Control nodes 320-324 may correspond to control nodes 124 of FIG. 1 and may perform orchestration functions, workload scheduling, membership maintenance, routing coordination, secure overlay establishment, and real-time cluster supervision. In various embodiments, the control nodes may also be deployed in a highly available arrangement. For example, the control nodes may share or replicate cluster membership tables, worker-node availability data, routing metadata, and performance measurements. In one embodiment, each control node may maintain a synchronized view of regional state so that any control node may respond to application or infrastructure requests without relying on a single master node. In some embodiments, leader-election or failover mechanisms may be used, such as Raft-based leader selection, a distributed lock service (e.g., ZooKeeper-style coordination), gossip-based cluster convergence, or heartbeat-driven failover logic in which control nodes monitor one another over secure communication channels. If a leading or primary control node becomes unreachable, another control node may automatically assume leadership, ensuring uninterrupted operation of the region.

Worker nodes 330-334 may represent the devices that contribute compute, storage, and networking capacity to the region. These devices may run the node software described with respect to FIG. 1, which instantiates virtual compute, network, and storage modules. In some embodiments, worker nodes may maintain persistent secure overlay connections to multiple control nodes to support fast failover. For example, a worker node may keep concurrent MTLS or VPN sessions open to Control Node A 320 and Control Node B 322. If one control node becomes unavailable, the worker node may continue receiving scheduling instructions, overlay-network updates, and module-management commands from another control node with minimal delay.

A DNS node 350 may also be present and may perform internal DNS resolution, service-discovery functions, cluster-internal routing name lookups, or load-balancing record distribution. In some embodiments, DNS node 350 may itself be replicated, with DNS Node A and DNS Node B operating in an active-passive or active-active configuration. Worker nodes and control nodes may use DNS node 350 to dynamically locate microservices, regional endpoints, or control-plane APIs.

The nodes in architecture 300 may communicate over one or more underlying networks collectively represented as Internet 340. Internet 340 may represent the public Internet, a private wide-area network, a corporate or enterprise backbone, a software-defined world area network (“WAN”), or any hybrid combination thereof. In some embodiments, certain nodes may communicate exclusively over private links (e.g., MPLS circuits, fiber backbones, private VPNs), while others may utilize public networks with additional encryption layers. Thus, “Internet 340” is used generically to refer to any packet-switched medium that provides connectivity between nodes.

Secure communications 344 may represent a logical overlay network that uses cryptographic protection to authenticate nodes and protect cluster-internal traffic. In various embodiments, secure communications 344 may be implemented using MTLS, internet protocol security (“IPsec”), WireGuard tunnels, quick UDP internet connections (“QUIC”) with transport layer security (“TLS”) 1.3, secure shell (“SSH”)-based tunnels, application-layer encryption, or combinations thereof. Node credentials may be established using certificates, hardware-backed keys, trusted platform module (“TPM”)-bound identities, WebAuthn credentials, pre-shared keys, or zero-trust onboarding mechanisms. In some embodiments, secure communications 344 may form a full-mesh encrypted overlay among all control nodes and admin nodes, while worker nodes may connect to one or more control nodes through hub-and-spoke topologies.

Secure communications 344 may also support redundancy and failover. For example, each node may maintain multiple concurrent secure channels to alternative communication peers. If a secure session drops, becomes unstable, or fails cryptographic validation, the node may immediately fail over to another secure tunnel without requiring external coordination. In some embodiments, nodes may periodically exchange heartbeat signals to detect failures or degraded performance across the secure overlay.

Open communications 346 may represent non-overlay or less-restricted communication channels over Internet 340. These may include public-facing secure hypertext transfer protocol (“HTTPS”) endpoints, DNS queries, status pages, unauthenticated monitoring endpoints, or traffic routed through non-mutual TLS. In some embodiments, open communications 346 may still be encrypted using TLS, but may not require mutual authentication or enrollment in the secure overlay network.

In operation, admin nodes 310-314 may coordinate with control nodes 320-324 using secure communications 344 to push configuration updates, retrieve cluster-wide metrics, synchronize policy definitions, or distribute administrative tasks. Because the admin nodes may be highly available, any admin node may continue servicing requests if another admin node fails. Likewise, control nodes 320-324 may use secure communications 344 to orchestrate worker nodes 330-334, distribute workload assignments, manage overlay routing, and coordinate with DNS node 350. If a control node becomes unreachable, another control node may immediately assume orchestration responsibility, and worker nodes with pre-established secondary secure channels may remain connected without interruption.

Although FIG. 3 depicts specific numbers of nodes and particular communication pathways, other embodiments may include additional nodes, merge functionalities into shared nodes, or distribute responsibilities differently. For example, administrative and control responsibilities may be combined into a unified class of control-plane nodes; DNS services may be integrated into control nodes; or the secure overlay may use alternative mesh-formation protocols such as gossip membership or decentralized key distribution. The arrangement shown in FIG. 3 therefore represents only one example of a fault-tolerant, highly available intra-regional communication environment and may be adapted to different deployment sizes, device capabilities, security requirements, or regulatory environments.

FIG. 4 illustrates an example sequence of operations 400 that may occur when a user interacts with the decentralized infrastructure to authenticate and request a service. The sequence of FIG. 4 is provided as one representative example and is not limiting; in other embodiments, messages may be reordered, combined, omitted, or implemented using different underlying protocols or components. As shown, FIG. 4 includes a user graphical user interface (“GUI”) 410, a DNS component 420, a control node 430, an admin node 440, and a worker node 450, each represented as a vertical lifeline. The user GUI 410 may correspond to an application interface 162, a control interface 172, or an infrastructure interface 142 as discussed with respect to FIG. 1, and may be implemented as a web browser, native application, command-line interface, or other user-facing software. DNS component 420 may represent one or more DNS resolvers, authoritative DNS servers, service-discovery mechanisms, or other mapping services. Control node 430 may correspond to a regional control node such as control node 124, admin node 440 may correspond to an administrative or authentication service such as an admin node 122, and worker node 450 may correspond to a worker node 130 capable of executing workloads.

In the example of FIG. 4, communication A may represent an initial DNS lookup from the user GUI 410 to DNS component 420. For instance, a user may enter a global URL such as “www.peercsn.com” into the GUI 410, and the user device may issue a DNS query (A) requesting the internet protocol (“IP”) address of an appropriate control node for the decentralized infrastructure. DNS component 420 may respond with communication B, which may include an IP address or hostname associated with a selected control node 430 or with a load balancer that fronts a set of control nodes. In some embodiments, the selection performed by DNS component 420 may involve Anycast routing, geolocation logic, latency measurements, or policy constraints similar to those described with respect to FIG. 2. In other embodiments, communications A and B may be omitted or replaced by cached DNS entries, static configuration, or other mechanisms by which user GUI 410 obtains the address of control node 430.

Once the address of the control node 430 is known, the user GUI 410 may establish an initial connection with the control node, as represented by communication C. Communication C may be a TCP, UDP, QUIC, or other transport-layer connection and may use TLS, MTLS, VPN encapsulation, or other security mechanisms as desired. In response to communication C, the control node 430 may return communication D, which may prompt the user GUI 410 to present a login interface or otherwise request authentication information from the user. Communication D may include hypertext markup language (“HTML”) content, an application program interface (“API”) response, a redirect to an authentication endpoint, or other instructions for initiating the login process.

The user GUI 410 may then submit authentication information to the control node 430 as communication E. Communication E may include, for example, a username and password, multi-factor authentication token, client certificate, open authorization version 2 (“OAuth2”) or OpenID Connect authorization code, security assertion markup language (“SAML”) assertion, WebAuthn token, or any combination thereof. In some embodiments, communication E may be sent over the same secure transport established by communication C, while in other embodiments a separate secure channel may be created specifically for authentication. Upon receiving communication E, the control node 430 may determine that it should verify the credentials using an admin node 440 or another authentication service.

To locate an appropriate admin node, the control node 430 may perform a DNS or service-discovery lookup as represented by communication F to DNS component 420. DNS component 420 may respond with communication G, which may include a hostname, IP address, or service endpoint for admin node 440. In some embodiments, communications F and G may be omitted if the control node 430 already maintains a registry of admin nodes, participates in a membership protocol that tracks admin-node addresses, or has been statically configured with such information. In other embodiments, the DNS component 420 may be implemented as an internal service-discovery system (such as a key-value store or service mesh control plane) instead of or in addition to conventional DNS.

After resolving the admin-node location, the control node 430 may send communication H to admin node 440. Communication H may encapsulate some or all of the credentials received in communication E or may comprise a token-introspection or validation request, depending on the authentication scheme used. For example, control node 430 may forward a username and password for verification, may request validation of a javascript object notation (“JSON”) Web Token (“JWT”) signed by a third-party identity provider, or may ask admin node 440 to check a certificate against a certificate authority or revocation list. Admin node 440 may process the request, consult user directories or credential stores, verify signatures, apply policy rules, and generate a result.

Admin node 440 may return communication I to control node 430, indicating whether the credentials are valid and, optionally, including authorization information such as user roles, scopes, resource entitlements, or jurisdictional constraints. In some embodiments, admin node 440 may also issue a new authentication token (for example, a signed JWT, opaque session identifier, or capability token) for use by control node 430 or user GUI 410 in subsequent requests. Control node 430 may then provide communication J back to user GUI 410. Communication J may indicate that authentication has succeeded and may request that the user specify a desired service, such as launching an application, provisioning virtual infrastructure, joining the network as a worker node, or accessing administrative controls. In the case of an authentication failure, communication J may instead present an error, a request for additional factors, or a prompt to retry login.

Assuming successful authentication, user GUI 410 may send a service request to control node 430 as communication K. Communication K may include details about the requested operation, such as the type and quantity of virtual resources desired, the application or service to invoke, performance objectives, or regulatory constraints associated with the data to be processed. Control node 430 may then determine which worker node or set of worker nodes is suitable for satisfying the request. In the embodiment shown, control node 430 may perform a DNS or service-discovery lookup (communication L) to DNS component 420 to resolve the address of an appropriate worker node 450 that is available, meets the requested criteria, and is permitted under relevant policies. DNS component 420 may respond with communication M, which may identify worker node 450 or multiple candidate worker nodes.

After selecting worker node 450, control node 430 may provision or schedule the requested job on worker node 450, as represented by communication N. Communication N may instruct worker node 450 to instantiate one or more virtual compute, network, or storage modules, to deploy containers or virtual machines, to configure overlay networking rules, or to access stored data needed for the job. Worker node 450 may execute the requested operation and generate corresponding results. Communication O may represent a response from worker node 450 back to control node 430, which may include status information, error codes, or application-level output. In some embodiments, worker node 450 may instead or additionally send responses directly to user GUI 410 via a separate channel, such as a WebSocket connection, Google™ remote procedure calls (“gRPC”) stream, or peer-to-peer overlay link, while still reporting summary status to control node 430 for accounting and monitoring purposes.

In the example of FIG. 4, control node 430 may forward some or all of the results received in communication O to user GUI 410 as communication P. Communication P may convey the final response for the requested service, such as an application page, an API response, a confirmation that infrastructure has been provisioned, or a streamed data result. In some embodiments, control node 430 may also log the transaction, update usage metrics, or notify admin node 440 of the completed operation for billing, auditing, or anomaly detection purposes. Although FIG. 4 depicts a particular sequence with distinct DNS, control, admin, and worker components, other embodiments may combine or separate these functions. For example, DNS component 420 may be integrated into control node 430, admin node 440 may also act as a control node and therefore eliminate communications F-I, or worker node 450 may maintain a long-lived secure connection directly to user GUI 410 that bypasses control node 430 for data-plane traffic while still relying on the control node for control-plane coordination. The sequence 400 is therefore illustrative of one way that the decentralized infrastructure may authenticate users and route their requests to appropriate worker nodes, and many variations may be implemented while remaining consistent with the techniques described herein.

FIG. 5 illustrates an example device-level networking architecture 500 that may be used to enable a wide range of personal, mobile, and IoT devices to join the decentralized global compute, storage, and networking infrastructure described herein. The arrangement shown in FIG. 5 is exemplary only. Other embodiments may use additional device types, different communication paths, additional intermediate networking components, or alternative software architectures for enabling devices to participate as nodes in the decentralized system. In the example of FIG. 5, an Example Region Control Plane 510 is shown communicatively coupled through an Internet 520 to multiple categories of end-user devices, including a Personal Computer 532 connected to a Home LAN 530, a Mobile Device 540, and an IoT Device 550.

The Example Region Control Plane 510 may correspond to the regional control plane described with respect to FIGS. 1-4. It may include one or more admin nodes, control nodes, DNS or service-discovery services, and secure communication gateways. The region control plane 510 may serve as the primary entry point through which devices register, authenticate, and join the decentralized infrastructure. In one embodiment, the region control plane 510 may publish registration endpoints or bootstrap nodes that are reachable through Internet 520. These endpoints may implement secure enrollment protocols through which new devices may establish cryptographically protected channels to the region.

Internet 520, as shown in FIG. 5, may represent any public or private packet-switched network capable of transporting traffic between user devices and the region control plane 510. Although depicted as a cloud symbol, Internet 520 may encompass a wide range of network types, including the public Internet, enterprise networks, home networks behind network address translation (“NAT”) devices, software-defined WAN overlays, VPN tunnels, carrier-grade NAT systems, mobile carrier networks, satellite links, mesh networks, or combinations thereof. In some embodiments, Internet 520 may be entirely private, such as a closed fiber-optic peering fabric connecting regional data centers. In other embodiments, device traffic may traverse a mixture of public and private segments depending on the device's network environment.

The Personal Computer 532 on Home LAN 530 represents an example of how a traditional household or office device may participate in the decentralized infrastructure. Personal Computer 532 may run node software or an agent that facilitates secure registration with the region control plane 510. Upon installation of the node software, the personal computer may establish a secure overlay tunnel—such as a mutually authenticated TLS connection, a WireGuard-based VPN, an IPsec tunnel, or another encrypted overlay—through Internet 520 to the region control plane 510. The node software may virtualize some or all portions of the device's underlying resources, including CPU time, memory, storage capacity, and network bandwidth. In an embodiment, the node software may provide container execution capabilities, allowing the device to run microservices, gateways, analytic tasks, or small distributed workloads on behalf of the decentralized system. In another embodiment, the personal computer may support virtual machines or hardware-accelerated environments, enabling it to function as a specialized worker node. The Home LAN 530 itself may include many devices, but only the personal computer 532 running the node software becomes part of the overlay, while other home-network devices remain isolated from the decentralized infrastructure for security and privacy.

Mobile Device 540 illustrates how a smartphone or tablet may join the infrastructure even when the device is connected through a cellular or wireless provider network. A user may download a mobile application that incorporates the node software or a lightweight worker-node agent. The mobile application may register the device with the region control plane 510 and establish a secure, persistent overlay tunnel to Internet 520 using protocols such as TLS 1.3, QUIC-based encrypted channels, WireGuard, IPsec, or custom encrypted transports optimized for mobile networks. Once joined, the mobile device may provide virtualized compute, storage, or network functions. For example, the mobile application may create virtual compute, storage, and network “pods” that execute within a sandboxed environment on the mobile device. These pods may be scheduled by the decentralized infrastructure to run certain classes of tasks appropriate to mobile constraints, such as short-lived computations, encrypted caching, or assistive peer-to-peer routing. In various embodiments, the mobile device may contribute only when plugged into power, only when idle, or only when connected to Wi-Fi, depending on user configuration.

IoT Device 550 illustrates how specialized or constrained devices—such as sensors, embedded controllers, smart appliances, edge computing units, or automobiles—may also join the decentralized infrastructure. An IoT Device 550 may run a scaled-down version of the node software, or it may connect through a gateway service that proxies its participation. For example, a smart thermostat may expose limited central processing unit (“CPU”) and storage resources but may nonetheless contribute to distributed computations, participate in routing overlays, or provide localized caching capacity. In other embodiments, IoT devices may join via intermediary home hubs, edge routers, or embedded cellular radios. As with other devices, IoT Device 550 may establish a secure encrypted tunnel to the region control plane 510, allowing it to authenticate, exchange heartbeat messages, advertise resource availability, and receive scheduled tasks suitable for its hardware profile.

Once a device such as Personal Computer 532, Mobile Device 540, or IoT Device 550 has successfully joined the decentralized network through region control plane 510, it may become a worker node and may contribute its virtualized compute, storage, or networking resources to the global pool. In some embodiments, each participating device may be classified as an “infrastructure provider,” as described previously. Infrastructure providers may receive compensation for the resources they share. Compensation may be calculated using a points-based metric, a tokenized reward system, a digital-currency credit, or any other fair-value mechanism that reflects compute cycles contributed, storage allocated, network capacity provided, uptime, latency performance, or task completion success. In some embodiments, the points earned by each device may be periodically uploaded to the region control plane 510, which may validate the values, aggregate them, and facilitate payout to the respective user accounts. The allocation rules for compensation may be globally uniform or may vary by region, jurisdiction, workload type, or resource scarcity.

In various embodiments, a device joining as a worker node may run containers, virtual machines, secure isolated processes, webassembly (“WASM”) runtimes, or interpreted execution environments depending on its hardware capabilities and user choice. The node software may automatically manage resource isolation, ensuring that workloads executed for the decentralized infrastructure do not interfere with the user's primary activities. The node software may additionally enforce security boundaries, preventing unauthorized access to the user's personal data, preventing lateral movement within the user's home local area network (“LAN”) 530, and ensuring that only the virtualized resources explicitly contributed by the user are made available to the network.

Although FIG. 5 shows only three device types, other embodiments may include laptops, gaming consoles, wearable devices, drones, industrial robots, home gateways, vehicles, or cloud-hosted devices that similarly join the decentralized system through secure tunnels. Likewise, while FIG. 5 depicts devices connecting through Internet 520 to a single Example Region Control Plane 510, devices may interact with multiple regions, may migrate between regions when traveling, or may participate in regional clusters based on geographic or regulatory boundaries as described in connection with FIG. 2. The architecture of FIG. 5 is therefore illustrative of one type of device attachment topology and is not limiting of the broader set of techniques by which diverse devices may be incorporated into the decentralized global infrastructure.

FIG. 6 illustrates an example method 600 for registering a new device as a potential worker node in a decentralized infrastructure. Method 600 is depicted as a series of logical operations that may be performed by one or more control devices cooperating with the device that is attempting to join the infrastructure. The blocks shown in FIG. 6 correspond to one representative ordering of operations; in other embodiments, operations may be reordered, combined, executed in parallel, or omitted, and additional operations may be inserted between those shown without departing from the scope of the disclosure. Method 600 may be implemented entirely in software executing on one or more processors, in firmware, in hardware logic, or in any combination thereof.

At block 610, the control devices may receive a registration request of a potential working node. The potential working node may correspond to the “registering device” discussed elsewhere, and may be any type of computing device capable of contributing resources to the decentralized infrastructure, such as a personal computer, laptop, server, virtual machine, container host, mobile device, tablet, smart television, home gateway, edge router, vehicular computing system, or IoT device. In an embodiment, the registration request may be initiated by node software that has been installed on the potential working node and configured with an address or identifier of a regional control plane. The node software may automatically establish a connection to the control devices, for example using an initial unencrypted channel that is upgraded to a secure channel, or using a pre-configured secure bootstrap mechanism. In another embodiment, a user of the potential working node may explicitly trigger registration through a graphical user interface, command-line tool, mobile application, or web portal, which may collect user consent, configuration preferences, or terms of service acknowledgments before transmitting the registration request to the control devices.

The registration request received at block 610 may contain a variety of information that facilitates evaluation and onboarding of the potential working node. For example, the request may embed a device identifier, user account identifier, public key, certificate, or other cryptographic material that can be used to authenticate the node and bind it to a particular user or account. The request may also include information about the type of device, the operating system, the version of the node software, supported execution environments, network addressing information, geolocation information, or jurisdictional indicators that describe where the device is physically located. In some embodiments, the registration request may further include one or more initial preferences or policies specified by the user, such as limits on the percentage of CPU or memory that may be used for decentralized workloads, time windows during which the device may participate as a worker (for example, only at night or only when idle), or whether particular classes of workloads (such as storage-intensive or network-intensive workloads) are permitted. By collecting this information at the time of registration, the infrastructure may apply fine-grained control over how each node participates, thereby improving user trust and simplifying later compliance checks.

At block 620, the control devices may determine resource capabilities of the potential working node. In an embodiment, determining resource capabilities may comprise receiving, from the potential working node, a capability report that includes at least one of available processor cycles, available memory, available storage capacity, available network bandwidth, presence of hardware accelerators such as graphics processing units (“GPUs”), tensor processing units (“TPUs”), or neural processing units (“NPUs”), supported instruction sets, or energy constraints such as battery level or power-source information. The capability report may be generated by the node software executing locally on the potential working node, which may query system APIs, device drivers, or hypervisor interfaces to identify the hardware and software resources that are realistically available for contribution to the decentralized infrastructure. In some embodiments, the capability report may distinguish between total resources and shareable resources, so that only the portion of the device's capacity not needed for local user activities is advertised to the infrastructure. For example, the node software may reserve a baseline amount of CPU and memory for the device's primary user and may expose only the remaining capacity for workloads from the decentralized infrastructure.

In addition to information provided directly by the potential working node, the control devices may augment their determination of resource capabilities with externally observed metrics. For example, after receiving the registration request, the control devices may perform one or more network probes or test exchanges to measure latency, packet loss, throughput, or connectivity stability between the control devices and the potential working node. These measurements may be used to characterize the node's effective network capabilities and to classify the node as suitable for latency-sensitive, bandwidth-intensive, or delay-tolerant workloads. The control devices may also consult historical records if the same device or user account has previously participated in the infrastructure, thereby incorporating prior reliability, uptime, and performance into the capability profile. By combining self-reported capabilities with externally measured behavior, the infrastructure can obtain a more accurate and robust view of each node's abilities, which improves later scheduling decisions and overall system reliability.

Determining resource capabilities at block 620 provides several benefits. First, it enables heterogeneous devices—including high-end servers, consumer laptops, mobile phones, and constrained IoT devices—to participate in the same decentralized infrastructure while still being matched to workloads that are appropriate for their capabilities. Second, it allows the control devices to enforce safety margins and ensure that nodes are not overloaded in ways that would degrade user experience on the host device. Third, it enables policy-based selection, such as preferring devices with particular accelerators for machine-learning tasks or preferring devices in certain bandwidth ranges for streaming workloads. Finally, by associating quantified capabilities with each node, the infrastructure can implement fair and transparent compensation schemes that reward participants in proportion to the resources they actually contribute.

At block 630, the control devices may create a resource module at the potential working node. In an embodiment, creating the resource module may involve the control devices transmitting configuration instructions, container manifests, virtual machine descriptors, or other deployment information to the node software on the potential working node. The node software may then instantiate one or more virtualized environments that will serve as the interface between the decentralized infrastructure and the underlying physical resources of the device. For example, in one embodiment the resource module may be implemented as a container runtime environment that hosts one or more containers, each of which executes workloads in isolated namespaces with restricted resource quotas. In another embodiment, the resource module may comprise a lightweight virtual machine or micro-virtual machine (“VM”) that provides stronger isolation at the cost of higher overhead. In still another embodiment, particularly for mobile or IoT devices, the resource module may be a sandboxed process or set of processes created within an application sandbox enforced by the operating system.

In some embodiments, the resource module created at block 630 may include separate logical submodules for compute, storage, and network functions. A virtual compute submodule may provide APIs for deploying and managing workloads such as microservices, jobs, or actors; a virtual storage submodule may expose object storage, key-value storage, or block-storage primitives for use by workloads; and a virtual network submodule may establish encrypted overlay tunnels, virtual interfaces, or routing tables that allow the node to communicate securely with control devices and other worker nodes. The control devices may tailor the structure and configuration of the resource module based on the capabilities determined at block 620 and on policies that govern different device classes. For example, a high-capacity server might be configured with multiple concurrent containers and significant storage quotas, whereas a battery-powered mobile phone might be configured with a single low-priority job queue and strict CPU and network limits. By establishing a standardized resource module abstraction across heterogeneous devices, the infrastructure can treat each device as a logical worker node with predictable behavior, which simplifies orchestration and improves security.

The creation of a dedicated resource module at the potential working node confers important benefits. It provides strong isolation between workloads sourced from the decentralized infrastructure and the user's personal applications and data on the device, reducing security risk and alleviating user privacy concerns. It allows fine-grained metering and control of resource usage, since all infrastructure workloads pass through a well-defined boundary where resource consumption can be measured and throttled. It also simplifies compatibility, because the control devices can interact with the resource module using standard APIs and orchestration protocols regardless of the underlying device type or operating system. Moreover, by encapsulating all infrastructure-related activity in a resource module that can be paused, stopped, or removed, the device owner retains control and can easily opt out or adjust participation without reconfiguring the entire system.

At block 640, after the resource module has been successfully created and any initial connectivity or security checks have been performed, the control devices may register the potential working node as an active member of the resource pool. In an embodiment, registering the node may involve creating or updating an entry in a resource registry or membership database that records the node's identifier, capability profile, current status, associated user or account, regional or jurisdictional classification, and the configuration of its resource modules. The node's status may be set to an “available,” “ready,” or “online” state, indicating that the node may be selected to execute workloads in response to service requests. The control devices may also establish persistent secure communication channels with the resource module, such as mutual TLS sessions, WireGuard tunnels, IPsec tunnels, or other encrypted overlays, and may store any session keys or tokens needed to maintain those channels. In some embodiments, the control devices may perform additional health checks or test workloads before marking the node as fully registered, thereby ensuring that the node can reliably execute real tasks.

In some embodiments, the registration operation at block 640 may further include initializing accounting or compensation data structures associated with the newly registered node. For example, the control devices may create an account record for the node's owner and associate it with a points balance, credit balance, or token wallet that will accrue value as the node executes workloads for the infrastructure. The registration process may store one or more compensation parameters, such as base rates per unit of compute or storage contributed, regional multipliers, or quality-of-service bonuses for high reliability. By tying these compensation mechanisms to the registration step, the infrastructure ensures that all subsequent workload execution can be accurately tracked and that participants receive rewards in proportion to their contributions. This, in turn, incentivizes users to register more devices and to keep them online and available, which strengthens the decentralized network as a whole.

The registration operations summarized in FIG. 6 can be adapted to a wide range of device types and deployment scenarios. For mobile devices, the registration request at block 610 may be generated by a mobile application obtained from an application store, and the capability determination at block 620 may include mobile-specific factors such as battery level, thermal conditions, or roaming status. The resource module created at block 630 may be implemented as a set of background services or pods that operate only when the device is charging or connected to Wi-Fi, thereby avoiding negative impact on the user's primary use of the device. For IOT devices, the capability determination may emphasize sensor types, local storage constraints, and intermittent connectivity patterns, and the resource module may be restricted to executing narrowly scoped, lightweight workloads. For high-end servers or cloud-hosted virtual machines, the capability report may describe very large resource quantities and specialized accelerators, and the resource module may be configured to host many concurrent workloads. In each case, method 600 provides a structured, policy-driven way to onboard devices into the decentralized infrastructure while respecting the practical limitations and preferences associated with each device class.

Overall, the registration method illustrated in FIG. 6 enables the decentralized infrastructure to grow organically from a diverse set of participant devices while maintaining control, security, and reliability. By explicitly receiving a registration request, determining resource capabilities, creating a standardized resource module, and registering the node into the pool, the system can safely transform heterogeneous personal and organizational devices into well-behaved worker nodes that can later be selected to fulfill service requests as described with respect to other figures. This architecture improves scalability, reduces reliance on centralized data centers, enables fine-grained compliance with legal or policy constraints, and allows participants to be compensated for their contributions in a transparent and auditable manner.

FIG. 7 illustrates an example method 700 for processing a service request using a pool of previously registered worker nodes in a decentralized infrastructure. Method 700 may be carried out by one or more control devices that coordinate operation of the infrastructure together with the worker nodes that contribute compute, storage, and networking capabilities. The sequence of operations shown in FIG. 7 provides one representative ordering that aligns with the method of claim 1; in other embodiments, operations may be combined, reordered, executed in parallel, or supplemented with additional operations, and not every step is required in every implementation.

At operation 710, the control devices may receive a service request. The service request may originate from any suitable requesting device, such as an end-user computer, a mobile device, a server associated with an application provider, a developer workstation, an administrative console, or even another worker node that is acting as a client of the infrastructure. The service request may be transmitted directly to a control device or may arrive through an intermediate component such as an application portal, control portal, or infrastructure services layer. In some embodiments, the service request may be received over a secure communication channel established using MTLS, a VPN tunnel, or another encrypted overlay network so that the integrity and confidentiality of the request are preserved while in transit over public or semi-public networks. The service request may specify a desired operation, such as executing a particular application, processing a batch of data, running a machine-learning model, performing an analytics query, hosting an API endpoint, storing or retrieving data, or performing a combination of these actions.

The service request received at operation 710 may include various parameters that allow the control devices to match the request with appropriate resources in the pool. For example, the request may identify a service type, workload class, or application identifier; it may specify minimum quantities of compute, storage, or network capacity required to satisfy the request; it may describe quality-of-service objectives such as latency targets, throughput targets, or deadlines; and it may indicate constraints related to data location, legal jurisdiction, or security classification. In some embodiments, the service request may carry authentication credentials or tokens that have been issued by an authentication subsystem, and the control devices may validate these credentials before honoring the request. The service request may further include user or tenant identifiers, billing information, or priority levels that influence how the request is scheduled relative to other pending requests.

At operation 720, the control devices may select a working node from the pool to service the request. The pool may comprise a set of resource devices that have previously completed the registration procedure described with respect to FIG. 6 and have been marked as available. For each resource device, the control devices may maintain a capability profile describing its compute capacity, storage capacity, network bandwidth, presence of hardware accelerators, device class (for example, server, desktop, mobile, or IoT), geographic location, and jurisdictional attributes, as well as current utilization and health metrics. Using this information, the control devices may evaluate which devices are candidates for fulfilling the request. In an embodiment, selecting the working node may involve identifying those devices whose capability profiles meet or exceed the resource requirements of the service request and then ranking the candidates according to one or more selection policies.

The selection policies applied at operation 720 may take into account many factors. For example, the control devices may prefer nodes that are geographically close to the requesting device or the relevant data sources in order to reduce latency and improve user experience. They may consider measured latency or bandwidth between the control devices and the candidate nodes, and may avoid nodes that exhibit poor network performance. The selection may also reflect jurisdictional restrictions or administrator-defined cross-region rules; for instance, if the service request involves personal data that must remain within a particular country or region, only nodes located in that jurisdiction may be eligible, or cross-border use may be allowed only when specific criteria are satisfied. Historical performance data may be used to prioritize nodes that have demonstrated high reliability and stable throughput. In some embodiments, cost considerations, energy efficiency considerations, or user-specific preferences may be incorporated into the selection logic. The result of operation 720 may be identification of a selected worker node that is expected to satisfy the service request while respecting all applicable technical and policy constraints. In some implementations, multiple worker nodes may be selected to handle different parts of a single service request, such as in sharded or replicated deployments; FIG. 7 represents the selection of at least one such node.

At operation 730, the control devices may provision a workload at the selected working node. Provisioning may involve transmitting one or more workload descriptors, configuration parameters, or deployment artifacts to the selected node. These artifacts may include container images, virtual machine images, application binaries, scripts, or configuration manifests describing how the workload should be instantiated within the resource module that resides on the node. The control devices may instruct the node to allocate portions of its virtual compute resources, virtual storage resources, and virtual network resources to the workload, in quantities determined by the service request and by internal scheduling algorithms. For container-based deployments, the provisioning step may involve instructing the node to create one or more containers, attach relevant storage volumes, configure environment variables, and join appropriate virtual networks or overlay tunnels. For virtual machine deployments, the provisioning may involve starting or resuming a virtual machine with specified resource quotas and attaching it to storage and networking resources controlled by the infrastructure.

In some embodiments, provisioning at operation 730 may also involve establishing or updating monitoring hooks, logging configurations, and security policies for the new workload. The control devices may configure health checks, telemetry streams, or tracing endpoints that allow them to observe the status and behavior of the workload during execution. They may also associate access-control rules that govern which external clients or other services are permitted to communicate with the workload, and may set up encryption keys or certificates that enable secure communication on data paths associated with the workload. In another embodiment, provisioning may be preceded by a brief admission-control evaluation that ensures that deploying the workload at the selected node will not cause resource contention or violation of service-level agreements; if the check fails, the control devices may return to operation 720 to select a different node.

At operation 740, the workload is executed at the selected working node. The node's resource module may instantiate containers, processes, or virtual machines as directed during provisioning, and the workload code may begin to run using CPU, memory, storage, and network resources of the node. Execution may involve handling incoming requests or messages from the requesting device or from other components of the decentralized infrastructure, performing computations, accessing local or remote storage, interacting with other services, or orchestrating subordinate tasks on additional worker nodes. In some embodiments, the workload may be designed as a microservice that exposes one or more APIs over the network; in others, it may be a batch job that processes a finite dataset and exits upon completion. For streaming or real-time analytics tasks, the workload may maintain long-lived connections and process continuous data flows.

The control devices may continuously or periodically monitor execution of the workload at operation 740. The node may send heartbeat messages, status updates, progress metrics, or performance measurements back to the control devices. If the workload or the node becomes unresponsive, exhibits error conditions, or fails health checks, the control devices may decide to intervene. In one embodiment, they may attempt to restart the workload on the same node; in another, they may reallocate the workload to a different node in the pool by returning to operation 720, selecting an alternate node, and performing another provisioning step at operation 730. This monitoring and reallocation behavior supports higher availability and resilience, allowing the infrastructure to continue satisfying service requests even when individual nodes fail or become degraded. In yet another embodiment, the monitoring data may be stored for later analysis to refine selection policies and to calculate compensation for node operators based on uptime, successful task completion, or resource consumption.

At operation 750, the working node generates a result responsive to the service request. The result may take many forms depending on the nature of the workload. It may be a specific output value, a data file, a transformed dataset, a rendered web page, an API response, a collection of analytics metrics, or an indication of success or failure. A workload that writes data into distributed storage may generate a result comprising identifiers or locations of stored objects. A workload that trains or updates a machine-learning model may generate updated model parameters or evaluation scores. In some embodiments, the working node may perform post-processing on the raw output, such as compressing the data, encrypting it for confidentiality, formatting it into a structured representation, or aggregating it with intermediate results from other nodes before producing a final result. The generation of the result may also include logging or checkpointing information that can be used to audit the execution or to resume partial computations in the event of a subsequent failure.

At operation 760, the result generated at the working node is communicated back to the requesting device, thereby completing the end-to-end service transaction. Communication may occur via several possible paths. In one embodiment, the working node sends the result to one or more control devices, which then forward the result to the requesting device via an application portal, control portal, or infrastructure services layer. This indirect path allows the control devices to enforce access control, perform protocol translation, redact sensitive fields, or augment the result with metadata such as timestamps, billing information, or resource-usage summaries. In another embodiment, the working node communicates the result directly to the requesting device over a secure channel, while still notifying the control devices of completion, for example by sending a completion message containing status information and resource usage metrics. In either case, the communication may be protected by encryption, integrity checks, and authentication measures to ensure that only authorized parties receive the result and that the result is not tampered with in transit.

The communication step at operation 760 may also trigger additional post-processing actions within the infrastructure. For example, the control devices may update accounting records to reflect resources consumed in servicing the request, which may later be used to charge the requesting user or to compensate the owner of the working node. They may update the node's health and performance statistics, which influence future selection decisions. They may release or reallocate any reserved resources associated with the workload, such as by terminating containers or virtual machines, detaching storage volumes, and reclaiming capacity in resource pools. In some embodiments, if the service request is part of a larger workflow or job composed of multiple stages, the result communicated at operation 760 may serve as input to subsequent service requests, which may themselves be handled by repeating method 700 for new workloads and potentially different worker nodes.

Method 700 thus provides a structured and flexible mechanism for dispatching service requests onto a heterogeneous pool of contributed devices in a way that harnesses their capabilities while preserving security, policy compliance, and reliability. By decoupling service-request handling into the operations of receiving the request, selecting an appropriate node based on rich capability and policy information, provisioning the workload, executing it with monitoring and potential reallocation, generating results, and communicating those results back to the requesting device, the decentralized infrastructure can support a wide variety of application types and usage models. This includes interactive web applications, batch analytics jobs, machine-learning workloads, storage services, and edge-computing scenarios involving mobile or IoT devices. The same method can be tailored to different legal environments and business arrangements by adjusting the selection policies, provisioning configurations, and post-processing behaviors, while the core flow remains consistent and general enough to cover the scenarios contemplated in the claims.

FIG. 8 illustrates an example computing system 800 that may be used to implement any of the control devices, admin nodes, worker nodes, infrastructure user devices, or requesting devices described in connection with the decentralized infrastructure. Computing system 800 is shown in simplified form for ease of explanation, and is not intended to limit the types of hardware, firmware, or software platforms that may be used. In practice, a given logical function of the decentralized infrastructure may be implemented by a single computing system 800 or by multiple such systems acting together.

Computing system 800 may include a central processor 810 coupled to other components by an interconnect or system bus 812. The central processor 810 may include one or more processing cores, which may be implemented using any suitable processor architecture, such as x86, advanced reduced instruction set machine (“ARM”), reduced instruction set version 5 (“RISC-V”), or a combination thereof. In some embodiments, the processor may include or be coupled to specialized accelerators such as graphics processing units, tensor processing units, neural processing units, or cryptographic accelerators that may be used to speed up particular classes of workloads. The central processor 810 may execute program instructions stored in memory 820, storage 830, or other non-transitory media to perform the operations described with respect to FIGS. 1-7, including receiving registration requests, determining resource capabilities, scheduling workloads, provisioning resource modules, and generating and returning results.

Memory 820 may represent one or more forms of volatile or non-volatile memory accessible to the central processor 810, such as random-access memory, static RAM, dynamic RAM, cache memory, or other semiconductor memory. In the embodiment illustrated, memory 820 may store various instruction modules that, when executed by the central processor 810, cause computing system 800 to implement logic associated with the decentralized infrastructure. For example, memory 820 may store registration instructions 822, which may include program code for receiving and processing registration requests from potential worker nodes, authenticating such requests, and orchestrating creation of resource modules on those nodes as described with respect to FIG. 6. Memory 820 may further store capability instructions 824, which may implement logic to obtain and interpret capability reports from devices, perform local or remote measurements of processing, storage, or network capacity, and construct capability profiles that characterize each node's resources and constraints.

Memory 820 may also store selection and scheduling instructions 826 that implement algorithms for selecting one or more devices from a pool of resource devices to service incoming requests. These instructions may evaluate resource capabilities, current utilization, latency measurements, geographic location, jurisdictional restrictions, user-defined policies, or historical performance data to determine where to place workloads, as discussed in connection with FIG. 7. In some embodiments, the selection and scheduling instructions 826 may support different scheduling strategies, such as round-robin placement, least-loaded placement, latency-aware placement, region-constrained placement, or cost-based optimization, any of which may be chosen or combined depending on configuration. Provisioning instructions 828 may implement program logic for deploying workloads to selected worker nodes, including transmitting container images or virtual machine descriptors, allocating virtual compute, network, and storage resources, establishing monitoring and logging hooks, and initiating or updating security policies relevant to the workload.

Storage 830 may represent one or more persistent storage devices associated with computing system 800, such as solid-state drives, hard disk drives, network-attached storage, storage-area networks, or non-volatile memory modules. Storage 830 may hold various data structures that support operation of the decentralized infrastructure. In the illustrated embodiment, capability storage 832 may store capability profiles or records for devices that have registered with the system, including their hardware characteristics, resource limits, reliability metrics, and jurisdictional attributes. Resource module images 834 may include container images, virtual machine images, application binaries, configuration manifests, or other artifacts used when instantiating resource modules on worker nodes. Policy and restrictions store 836 may hold regional policies, administrator-defined rules governing cross-region communication or workload placement, quality-of-service policies, and security or compliance rules that may be consulted by the selection and scheduling instructions 826 or provisioning instructions 828. Execution logs and telemetry store 838 may contain logs, metrics, traces, and other telemetry associated with workloads and nodes, which may be used for monitoring, failure detection, accounting, compensation, or subsequent analysis.

Computing system 800 may further include a network interface 840 coupled to the system bus 812. Network interface 840 may represent one or more physical or virtual network adapters that provide connectivity to external systems and networks. In different embodiments, the network interface may support wired Ethernet, optical links, wireless fidelity (“Wi-Fi”), cellular radio, satellite links, or other communication technologies. The network interface 840 may be configured to establish secure channels such as Transport Layer Security sessions, MTLS connections, VPN tunnels, or encrypted overlay networks used for communication between control devices, admin nodes, worker nodes, and external user devices as described with respect to FIGS. 1-3. In some embodiments, network interface 840 may support multiple network paths simultaneously, allowing computing system 800 to participate in both public and private networks or to interface with dedicated management networks and data networks.

An I/O controller 850 may be coupled to the system bus 812 and may manage communication between the central processor 810, memory 820, and various peripheral components. As illustrated, I/O controller 850 may be connected via an input/output (“I/O”) bus 852 to user input devices 854 and user output devices 854. User input devices may include keyboards, mice, touchscreens, microphones, or other devices by which an administrator or user may interact with the system, for example to configure cluster behavior, view monitoring dashboards, or manually approve registration requests. User output devices may include displays, speakers, printers, or other output peripherals that present information such as system status, logs, or results of workloads. In some embodiments, I/O controller 850 may also interface with local sensors, storage media, or other hardware that may be present when computing system 800 functions as an edge device or worker node.

Computing system 800 may further include a kernel 860, which may represent operating system kernel software, firmware, or a combination thereof that provides foundational services such as process scheduling, memory management, device drivers, and low-level networking. Within kernel 860 or tightly coupled to it, various subsystems may be implemented to support virtualization and secure execution of workloads. In the illustrated embodiment, a hypervisor 862 may provide hardware-assisted virtualization, enabling computing system 800 to host one or more virtual machines on which control-plane or worker-node logic executes. The hypervisor 862 may be a Type-1 bare-metal hypervisor or a Type-2 hypervisor operating atop a host operating system. A container engine 864 may implement containerization functions, such as managing container images, creating and destroying containers, allocating namespaces and cgroups, and enforcing resource quotas that isolate workloads from one another on the same host. An isolated execution module 866 may provide additional security or isolation primitives, such as sandboxing frameworks, secure enclaves, or trusted execution environments, which may be used when executing sensitive workloads or enforcing multi-tenant separation.

A security subsystem 868 may provide cryptographic and access-control services used by the other modules of computing system 800. The security subsystem 868 may manage keys and certificates for mutual TLS connections, validate authentication credentials supplied by registering devices or requesting devices, enforce role-based or attribute-based access control policies, and generate or verify digital signatures on messages exchanged within the decentralized infrastructure. In some embodiments, security subsystem 868 may interface with hardware security modules, trusted platform modules, or secure enclaves that provide tamper-resistant storage of keys and secure execution of cryptographic operations.

Although FIG. 8 illustrates particular groupings of instruction modules and data stores, these are provided as one example organization. In other embodiments, the same functionality may be arranged differently, merged, further subdivided, or distributed across multiple physical machines. For instance, registration instructions 822 and capability instructions 824 may execute on one cluster of servers that specialize in onboarding nodes, while selection and scheduling instructions 826 may execute on a separate cluster that focuses on runtime orchestration. Similarly, the data structures shown in storage 830 may be partitioned across different databases or replicated across regions to improve resilience and locality. Any of the modules and data stores depicted in FIG. 8 may be implemented in hardware, software, firmware, or combinations thereof, and program instructions may be stored in any non-transitory computer-readable media.

In operation, when computing system 800 acts as a control node, the central processor 810 may execute registration instructions 822, capability instructions 824, selection and scheduling instructions 826, and provisioning instructions 828 to perform the registration and workload-allocation methods described in FIGS. 6 and 7. When computing system 800 acts as a worker node, the same hardware platform may execute node software using container engine 864 or hypervisor 862, with the resource module images 834 being instantiated under control of provisioning instructions 828 and isolated execution module 866. When computing system 800 functions as an administrator interface or infrastructure user device, user input and output devices 854 may be more heavily used, while the same network interface 840 and security subsystem 868 may ensure secure interaction with remote control planes. Thus, the generalized architecture of FIG. 8 may serve as a basis for any node type or user-facing device participating in the decentralized infrastructure, enabling heterogeneous devices to be described and implemented in a common framework.

The following embodiments illustrate additional optional behaviors and architectural variations of the decentralized infrastructure that may be incorporated individually or in combination with any of the embodiments described above. In some embodiments, the decentralized infrastructure may be designed with the expectation that many worker nodes will be intermittently available, may frequently join or leave the network, or may experience substantial variation in their usable capacity over time. For example, participant devices such as laptops, mobile phones, and IoT devices may be powered off, disconnected from the network, placed into low-power modes, or otherwise unable or unwilling to contribute resources during certain periods. To accommodate this dynamic and largely uncontrolled environment, the control plane may treat the resource pool as inherently ephemeral, continually updating internal representations of node availability based on heartbeat messages, status reports, and observations of successful or failed workload executions. In some embodiments, worker nodes may advertise that they are temporarily unavailable for new workloads, such as when a device is on battery power below a threshold, is actively used by a local user, or is connected over a degraded network link, and the control plane may refrain from assigning new tasks to such nodes until their status improves.

In some embodiments, the control plane may maintain historical statistics and predictive metrics associated with each worker node or class of nodes, and may use those metrics when determining how and when to place workloads. For example, the control plane may track uptime patterns, typical session durations, historical failure rates, observed bandwidth stability, or time-of-day availability for individual devices or device cohorts, and may preferentially assign long-running or latency-sensitive workloads to nodes with higher reliability scores or more stable connectivity patterns. Short-lived, best-effort, or easily replicated tasks may be preferentially scheduled on nodes with more volatile availability. In various embodiments, the control plane may also replicate or shard workloads across multiple nodes to compensate for expected churn in the resource pool, and may proactively migrate or reschedule workloads when predictive metrics indicate an elevated risk of disconnection or resource loss. By explicitly modeling and reacting to the intermittent nature of contributed devices, the decentralized infrastructure may make effective use of idle resources while preserving overall reliability and user experience for requesting devices.

In additional embodiments, the decentralized infrastructure may incorporate one or more compensation mechanisms through which participant devices are remunerated for contributing compute, storage, or networking resources. Compensation may be implemented using any suitable economic model, including fixed-rate payouts, variable-rate payouts, or hybrid incentive structures. For example, the system may assign points, tokens, credits, or other abstract resource units to each participant device, where the number of units earned is based on factors such as contributed compute cycles, contributed memory, contributed storage, network throughput provided, or duration of uptime. These units may be convertible to fiat currency, digital currency, platform-specific credits, reduced service fees, service-tier upgrades, or priority access to future resources. In some embodiments, the rate at which participant devices accumulate compensation may vary depending on the geographic region of the device, scarcity of resources in that region, performance characteristics of the device, or compliance with quality-of-service guarantees. For instance, a device located in a region experiencing high demand or limited capacity may accumulate compensation at an elevated rate relative to devices located in oversupplied areas.

The system may also incorporate dynamic pricing algorithms that adjust compensation rates in real time based on observed load, predicted demand, historical usage patterns, reliability metrics, operator-defined policies, or fairness objectives. In one embodiment, a device that consistently maintains high availability, low latency, or low error rates may receive a bonus multiplier. In another embodiment, participant devices may be compensated for meeting or exceeding predefined service-level thresholds, such as minimum uptime percentages or latency targets. Conversely, devices exhibiting frequent failures or degraded performance may accumulate compensation at a reduced rate or may be temporarily removed from the resource pool until performance returns to acceptable levels.

In other embodiments, compensation may be proportional to successful execution of workloads. For example, each successful completion of a task may yield a defined credit amount, which may vary based on task category, computational intensity, memory requirements, or storage demands. Certain applications may allow participant devices to opt into priority queues, where elevated compensation is offered for executing workloads that require enhanced reliability, increased computational strength, or specialized hardware such as GPUs, TPUs, or quantum processors. The system may further support “market-driven” economic models, wherein application builders or end users submit bids for workload execution and participant devices receive compensation based on accepted bids.

In some embodiments, the compensation mechanism may also reward non-computational contributions, such as participating in routing, caching, or replication activities that enhance overall network performance or resilience. For example, a participant device that temporarily stores replicated data as part of a redundancy protocol may receive compensation proportional to storage duration or replication volume. The economic models described herein may be implemented through smart contracts, distributed ledgers, centralized accounting systems, or hybrid systems combining local and global state. All such compensation mechanisms may operate independently or in combination, and no particular compensation scheme is required for every embodiment.

In further embodiments, the decentralized infrastructure may incorporate jurisdiction-specific policy mechanisms that govern how workloads, data, or resource contributions are permitted to flow between regions. These mechanisms may be implemented by the control plane of each region, by global coordination nodes, or by any combination thereof. A region or cluster may be associated with a particular legal boundary such as a country, province, economic zone, or compliance domain. In such embodiments, the system may enforce rules requiring that certain workloads, categories of data, or user accounts remain within the jurisdiction associated with the originating region. For example, the control plane may prevent execution of a workload on devices physically located outside an approved geographic boundary, or may prevent transfer of application data to devices operating in other countries unless explicitly permitted by an administrator-defined policy.

Administrators may define one or more cross-region compliance rules specifying when and how regions may communicate. These rules may govern matters such as whether a given workload type may leave a region, which destination regions are eligible for inter-region routing, whether encrypted state summaries may be shared, and whether metadata regarding resource availability may be exchanged. In some embodiments, these rules may be expressed as declarative compliance policies that the control plane automatically applies when selecting devices across regions. Thus, if a service request originates from a jurisdiction that mandates data locality (e.g., general data protection regulation (“GDPR”)-like restrictions), the control plane may automatically constrain device selection to the originating region or to a permissible subset of regions predefined by the administrator.

In other embodiments, a region may be part of a federated cluster of sub-regions within the same jurisdiction, allowing tasks and information to flow freely within the cluster while applying more restrictive rules to communication outside the cluster. For example, a country may contain multiple internal regions that share workloads and resource information liberally for performance and redundancy, while still treating all devices outside the country as external and therefore subject to cross-border limitations. Administrators may dynamically modify these jurisdictional constraints to account for changes in legal requirements, evolving privacy rules, or temporary operational needs. The control plane may continually enforce the currently active compliance rules by evaluating each service request, assessing region eligibility based on the request's metadata, and limiting or allowing inter-region routing accordingly.

In still other embodiments, regions may selectively share only high-level operational state—such as aggregate capacity summaries, health metrics, or compliance-approved metadata—while withholding user data, application data, or workload-specific information from unauthorized regions. This may allow global optimization and routing without violating jurisdictional privacy requirements. The system may further support tiered or hierarchical compliance models in which one set of rules applies globally, another set applies to regional clusters, and additional rules apply to individual regions. All such jurisdictional policy mechanisms may operate independently or in combination, and no specific legal boundary, rule format, or enforcement mechanism is required in every embodiment.

In additional embodiments, the decentralized infrastructure may employ one or more privacy-preserving execution techniques to protect user data, workload content, and operational metadata from unauthorized access. These techniques may be implemented at the level of individual resource modules, at the worker device level, or at the control plane level. For example, a worker device may execute assigned workloads within a secure enclave or trusted execution environment (TEE), such as those provided by Intel software guard extensions (“SGX”), Advanced Micro Devices' (“AMD”) secure encrypted virtualization (“SEV”), ARM TrustZone, or other hardware-backed isolation technologies. Such enclaves may allow the device to execute sensitive computations in an encrypted memory space that is inaccessible to the local operating system, hypervisor, or other co-resident processes, thereby preserving confidentiality even when workloads are executed on untrusted devices.

In some embodiments, the infrastructure may support hardware-backed attestation processes that allow the control plane to verify that a registering device is executing approved software, firmware, or enclave code before allowing it to participate in the resource pool. Attestation results may be evaluated against policy-defined trust thresholds, and devices failing attestation may be denied participation, assigned only low-sensitivity workloads, or flagged for administrator review. These attestation processes may also verify measured boot chains, device identities, or enclave integrity values, and may operate periodically or continuously to ensure ongoing compliance with security policies.

Other embodiments may incorporate zero-knowledge verification mechanisms enabling worker devices to prove the correctness of certain computations without revealing the underlying data or workload content. For example, the device may generate a zero-knowledge proof that it executed a computation according to prescribed rules, which may allow the decentralized infrastructure to validate correctness while preserving privacy. Optional embodiments may implement differential privacy techniques that introduce calibrated noise into aggregated metrics, usage statistics, or performance logs, thereby allowing regions to share operational information for load balancing or capacity planning without exposing user-specific details.

Still other embodiments may provide enhanced sandboxing or isolation strategies beyond containerization or virtual machines. For example, a worker device may execute workloads inside multi-layered sandboxes comprising a VM boundary, a container boundary, and a process-level isolation boundary, with each layer providing defense-in-depth protection against data leakage or unauthorized workload inspection. These sandboxes may restrict network access, filesystem access, inter-process communication, or system calls, and may enforce ephemeral execution modes in which all workload-specific data is destroyed after execution.

Any of the privacy-preserving mechanisms described herein may be used individually or collectively. No particular technology is required in every embodiment, and different regions or administrators may define distinct privacy policies based on regulatory requirements, risk tolerance, or workload sensitivity. These privacy-preserving techniques may further operate alongside the jurisdictional enforcement rules and resource-allocation mechanisms described above to provide layered protection across the decentralized infrastructure.

In additional embodiments, the decentralized infrastructure may implement hierarchical orchestration models in which multiple layers of control planes cooperate to manage resource allocation, workload execution, and network state across the system. These hierarchies may include, for example, a global control tier responsible for high-level coordination between countries or large jurisdictional clusters, a regional control tier responsible for managing resources within a particular country or compliance zone, and a zone-level or local control tier responsible for managing closely grouped worker nodes or locally dense subclusters. Each tier may maintain responsibility for a distinct scope of operations while sharing summarized state information with higher or lower tiers according to administrator-defined rules.

In one embodiment, a global control plane may maintain awareness of overall system capacity, aggregate health metrics, and cross-region compliance restrictions, and may selectively propagate routing metadata or replication directives to regional control planes. These regional control planes may, in turn, perform more granular orchestration such as selecting worker groups, enforcing jurisdictional boundaries, or optimizing local network paths. Zone-level or local control planes may manage short-range cluster behavior such as distributing tasks among nearby devices, executing fault recovery actions within the subcluster, or balancing workloads across devices with similar hardware capabilities or network proximity.

In some embodiments, the hierarchical model may operate as a federation of semi-autonomous control planes, each capable of independent operation while still participating in coordinated decision-making. For example, each regional control plane may advertise summaries of its available resource capacity, demand forecasts, replication needs, or service constraints to neighboring regions or to the global tier. These advertisements may be exchanged periodically, on demand, or in response to system events such as spikes in workload volume or failures in upstream tiers. The global tier may analyze these aggregated summaries and issue system-wide recommendations, enforce compliance policies, or redistribute workloads among regions that have opted into cross-region collaboration.

In other embodiments, control planes may participate in peer-to-peer negotiation rather than operating strictly under a hierarchical structure. For example, two regions may negotiate transfer of workloads, reallocation of resources, or cooperation on shared redundancy strategies without requiring centralized global oversight. The negotiation process may include evaluating jurisdictional constraints, workload types, current load, latency requirements, or available capacities, and may be governed by an administrator-defined policy framework. Peer negotiation may also allow rapid adaptation to dynamic conditions, such as sudden demand in one region or temporary unavailability of control devices in another.

Still other embodiments may use adaptive hybrid models in which the infrastructure initially operates with a global-regional hierarchy but automatically transitions to peer-to-peer or zone-local modes in response to disconnections, high latency, or disaster recovery scenarios. For instance, if global coordination becomes temporarily unavailable, regional control planes may continue to operate independently and maintain service continuity within their geographic scope, while re-synchronizing with the global tier when connectivity is restored. Similarly, if a region becomes partitioned, zone-level control planes may coordinate workload execution among nearby devices and maintain local policies until regional connectivity is recovered.

These hierarchical and federated orchestration models may exist independently or in combination, and the system may dynamically select or blend orchestration strategies based on network topology, regulatory constraints, or operational goals. No particular hierarchy depth, tier naming scheme, or control-plane coordination mechanism is required in every embodiment.

In additional embodiments, the resource modules instantiated on a registering device may include specialized components beyond the virtual compute, virtual storage, and virtual network modules described above. A worker device may expose any combination of heterogeneous resource types depending on its hardware capabilities, battery state, thermal characteristics, or administrator-defined participation preferences. For example, a worker device may include a hardware-accelerated compute module configured to expose access to one or more GPUs, TPUs, NPUs, FPGAs, ASIC-based accelerators, quantum co-processors, vector engines, or other specialized computational hardware. These accelerator modules may be used to perform machine-learning inference, scientific simulations, image/video processing, cryptographic computations, or other workloads that benefit from hardware acceleration.

In some embodiments, a device may also expose memory-focused resource modules that distinguish between volatile memory (e.g., dynamic random access memory (“DRAM”), high bandwidth memory (“HBM”)) and non-volatile memory (e.g., not and (“NAND”) flash, persistent memory, byte-addressable non-volatile dual in-line memory module (“NVDIMM”)). The decentralized infrastructure may treat these memory resources as schedulable elements when selecting a device to fulfill a workload. For instance, a workload requiring low-latency access to large in-memory datasets may be routed to devices with high-speed volatile memory capacity, whereas workloads requiring durable or semi-persistent storage layers may be routed to devices exposing large non-volatile memory pools.

Network-related resource modules may likewise include capabilities beyond simple virtual network interfaces. For example, in some embodiments, a worker device may expose a network-acceleration module that provides enhanced packet-forwarding performance, built-in cryptographic acceleration for secure channels, software-defined networking offload features, or support for multiple network pathways with varying latency and throughput characteristics. The control plane may evaluate these network features when selecting nodes for latency-sensitive workloads or for workloads requiring significant east-west communication.

In further embodiments, the decentralized infrastructure may incorporate power-awareness and thermal-awareness when exposing or scheduling resource modules. A mobile device, laptop, or IoT device may report its battery level, charging state, thermal margin, CPU/GPU temperature, or fan speed, and the control plane may allocate workloads accordingly. For example, a device operating in a low-battery condition may participate only in lightweight, low-power workloads or may temporarily opt out of participation. Conversely, a device that is plugged in, thermally stable, or configured for “high-performance mode” may be eligible for more intensive workloads. The system may also allow devices to participate only during certain power states—such as while charging, while connected to wall power, or while operating within predefined thermal envelopes.

Real-time constraints may also influence resource module selection. In some embodiments, a worker device may expose a “real-time execution module” configured to provide deterministic scheduling, reduced jitter, or access to hardware timers or real-time kernels. Workloads requiring real-time guarantees may therefore be routed to nodes with appropriate hardware or software configurations. Other devices may expose “low-power mode modules” in which workloads run with reduced frequency, reduced voltage, or reduced memory bandwidth for energy efficiency.

The resource modules described herein may be dynamically created, modified, or retired based on device conditions, administrative rules, firmware capabilities, or workload characteristics. Each device may advertise a capabilities profile to its regional control plane, and the control plane may maintain a continuously updated view of available resource types, performance metrics, and constraints across the region. These expanded resource modules may operate independently or in combination with one another and may be implemented using any suitable virtualization, containerization, driver-level abstraction, or hardware-level interface. No particular resource type is required in every embodiment, and different devices may expose different subsets of modules depending on their capabilities and operating conditions.

In some embodiments, the decentralized infrastructure may support optional “local execution modes” that allow certain workloads or communications to bypass wide-area networks entirely. For example, two or more worker devices located on the same LAN, private subnet, campus environment, enterprise intranet, or edge cluster may establish direct peer-to-peer connections without traversing the public Internet. This mode may reduce latency, improve throughput, and allow execution of workloads that require ultra-low network overhead or regulatory confinement to a local physical environment. In some embodiments, a regional control plane may detect that the requesting device and one or more worker nodes share a common LAN or local gateway and may provision the workload using a local overlay pathway that remains fully contained within that network boundary.

In additional embodiments, mobile devices or IoT devices may engage in device-to-device communication under a “proximity execution mode,” where workloads or partial workloads are exchanged directly over Bluetooth, Wi-Fi Direct, device-to-device 5G, mesh networking, or other peer-level transports. These local bypass paths may be selected automatically when network conditions, jurisdictional rules, or user preferences indicate that local execution is preferred. In some embodiments, the system may restrict certain classes of data or workloads to remain local (e.g., privacy-sensitive data, regionally regulated data), and the control plane may enforce this by selecting only nodes on the same LAN, local cluster, or jurisdictional boundary. These local modes are optional and may be used alongside, or instead of, wide-area orchestration depending on configuration and policy.

In some embodiments, the decentralized infrastructure may implement a multi-layered failover and high-availability framework for both control-plane components and worker nodes. Control nodes may participate in leader-election protocols such as Raft, Paxos, Viewstamped Replication, or other consensus-driven coordination systems. A primary control node may be elected to coordinate workload scheduling, while one or more secondary or “hot standby” nodes may maintain synchronized state and be prepared to assume leadership if the primary becomes unreachable. State replication may include membership tables, capability profiles, routing metadata, security credentials, and scheduling queues, all updated through gossip-style convergence protocols, log-replication mechanisms, or incremental state-diff exchanges.

In additional embodiments, the control plane may continuously evaluate node health using heartbeat checks, latency scoring, reliability history, failure-prediction heuristics, or rolling performance windows. If a worker node or a control node fails a health threshold, becomes unstable, or exceeds defined timeout values, the control plane may automatically reassign workloads to alternative nodes and reestablish required overlay connections. This failover behavior may occur without human intervention and may be transparent to requesting users. In some configurations, the system may proactively replicate workloads or maintain “warm replicas” on alternate nodes, enabling near-instant recovery when a failure occurs. These high-availability strategies allow the decentralized infrastructure to maintain continuous operation across heterogeneous devices and network conditions.

In additional embodiments, the decentralized infrastructure may expose higher-level application or service models beyond raw compute, storage, and networking resources. For example, the control plane may provide a serverless execution environment in which workloads are submitted as short-lived functions or tasks that run within ephemeral execution sandboxes on worker nodes. These functions may be deployed without requiring users to manage underlying virtual machines, containers, or resource modules directly, and may execute only in response to triggering events, API calls, scheduled timers, or workflow orchestration rules.

In further embodiments, the infrastructure may provide platform-level hosting capabilities, such as application runtime environments, database services, API gateways, static-site hosting, message queues, stream-processing services, or other PaaS-style components. The control plane may route application-level requests to appropriate worker nodes capable of running the required runtime (for example, a particular programming language environment, machine-learning inference engine, or specialized accelerator module). Worker nodes may execute the application logic within their resource modules while preserving isolation, applying policy constraints, and reporting resource usage for billing or compensation.

In some embodiments, users may deploy multi-tenant applications that span multiple worker nodes across a region or across multiple regions, with the control plane automatically managing horizontal scaling, load balancing, request fan-out, and state synchronization. The decentralized infrastructure may support long-lived application endpoints, WebSocket streams, event-driven services, or microservice meshes distributed across heterogeneous devices. These higher-level service models may be layered on top of the compute, storage, and networking abstractions described throughout this disclosure and may operate independently or in conjunction with those lower-level abstractions. No particular application model is required in all embodiments.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A method for operating a decentralized infrastructure comprising:
receiving, at one or more control devices, a registration request from a registering device;
determining, by the one or more control devices, one or more resource capabilities of the registering device, the resource capabilities comprising at least one of compute capacity or storage capacity;
causing creation, at the registering device, of one or more resource modules configured to expose at least a portion of the resource capabilities of the registering device to the decentralized infrastructure;
registering, at the one or more control devices, the registering device in a pool of resource devices;
receiving, at the one or more control devices, a service request from a requesting device;
selecting, based on the service request and on current availability of the resource capabilities of devices in the pool, a selected device to fulfill at least a portion of the service request;
provisioning, at the selected device, one or more workloads corresponding to the service request;
executing, by the selected device, the one or more workloads;
generating, by the selected device, one or more results responsive to the service request; and
communicating the results to the requesting device;
wherein the method is performed on one or more processors.

2. The method of claim 1, wherein determining the one or more resource capabilities comprises receiving, from the registering device, a report identifying at least one of available processor cycles, available memory, available storage capacity, or available network bandwidth.

3. The method of claim 1, wherein causing creation of the one or more resource modules comprises initiating, at the registering device, a containerized execution environment, a virtual machine, or an isolated process space configured to execute workloads for the decentralized infrastructure.

4. The method of claim 1, wherein the registration request includes an authentication credential, and registering the registering device in the pool of resource devices comprises authenticating the credential using at least one of a token-based protocol, a certificate-based protocol, or a multi-factor authentication protocol.

5. The method of claim 1, wherein receiving the service request comprises receiving the service request through a secure communication channel established using at least one of mutual transport layer security, a virtual private network tunnel, or an encrypted overlay network.

6. The method of claim 1, wherein selecting the selected device comprises selecting the selected device based on at least one of geographic proximity, latency measurements, jurisdictional restrictions, or historical performance of devices in the pool.

7. The method of claim 1, wherein provisioning the one or more workloads comprises directing the selected device to allocate virtual compute resources, virtual network resources, or virtual storage resources corresponding to the service request.

8. The method of claim 1, wherein executing the one or more workloads comprises executing at least one containerized microservice or virtualized task using the one or more resource modules.

9. The method of claim 1, further comprising monitoring, by the one or more control devices, execution status of the one or more workloads and reallocating the workloads to a different device in the pool in response to detecting an execution failure or communication failure of the selected device.

10. The method of claim 1, wherein communicating the results to the requesting device comprises transmitting the results through at least one of an application portal, a control portal, or an infrastructure services layer.

11. The method of claim 1, wherein registering the registering device in the pool of resource devices further comprises assigning a compensation value to the registering device based on an amount of compute capacity or storage capacity contributed to the decentralized infrastructure.

12. The method of claim 1, wherein receiving the registration request comprises receiving the registration request from a mobile device, and causing creation of the one or more resource modules comprises creating virtualized compute, storage, or network pods within a mobile software application.

13. The method of claim 1, wherein the registering device comprises an internet-of-things device, and determining the one or more resource capabilities comprises identifying a constrained set of available resources suitable for executing lightweight workloads.

14. The method of claim 1, wherein the one or more control devices operate within a first region, and selecting the selected device further comprises determining whether the service request is permitted to be fulfilled by a device located in a second region in accordance with one or more administrator-defined cross-region rules.

15. One or more non-transitory computer-readable media storing instructions that, when executed by one or more hardware processors, cause performance of operations comprising:
receiving, at one or more control devices, a registration request from a registering device;
determining, by the one or more control devices, one or more resource capabilities of the registering device, the resource capabilities comprising at least one of compute capacity or storage capacity;
causing creation, at the registering device, of one or more resource modules configured to expose at least a portion of the resource capabilities of the registering device to the decentralized infrastructure;
registering, at the one or more control devices, the registering device in a pool of resource devices;
receiving, at the one or more control devices, a service request from a requesting device;
selecting, based on the service request and on current availability of the resource capabilities of devices in the pool, a selected device to fulfill at least a portion of the service request;
provisioning, at the selected device, one or more workloads corresponding to the service request;
executing, by the selected device, the one or more workloads;
generating, by the selected device, one or more results responsive to the service request; and
communicating the results to the requesting device.

16. The one or more non-transitory computer-readable media of claim 15, wherein the operations further comprise: determining the one or more resource capabilities comprises receiving, from the registering device, a report identifying at least one of available processor cycles, available memory, available storage capacity, or available network bandwidth.

17. The one or more non-transitory computer-readable media of claim 15, wherein causing creation of the one or more resource modules further comprises: initiating, at the registering device, a containerized execution environment, a virtual machine, or an isolated process space configured to execute workloads for the decentralized infrastructure.

18. A system comprising:
at least one device including a hardware processor; and
one or more non-transitory computer-readable media storing program instructions which, when executed by the hardware processor, cause the system to perform operations comprising:
receiving, at one or more control devices, a registration request from a registering device;
determining, by the one or more control devices, one or more resource capabilities of the registering device, the resource capabilities comprising at least one of compute capacity or storage capacity;
causing creation, at the registering device, of one or more resource modules configured to expose at least a portion of the resource capabilities of the registering device to the decentralized infrastructure;
registering, at the one or more control devices, the registering device in a pool of resource devices;
receiving, at the one or more control devices, a service request from a requesting device;
selecting, based on the service request and on current availability of the resource capabilities of devices in the pool, a selected device to fulfill at least a portion of the service request;
provisioning, at the selected device, one or more workloads corresponding to the service request;
executing, by the selected device, the one or more workloads;
generating, by the selected device, one or more results responsive to the service request; and
communicating the results to the requesting device.

19. The system of claim 18, wherein the operations further comprise: determining the one or more resource capabilities comprises receiving, from the registering device, a report identifying at least one of available processor cycles, available memory, available storage capacity, or available network bandwidth.

20. The system of claim 18, wherein causing creation of the one or more resource modules further comprises: initiating, at the registering device, a containerized execution environment, a virtual machine, or an isolated process space configured to execute workloads for the decentralized infrastructure.
